(19) United States
(12) Patent Application Publication
(10) Pub. No.: US 2023/0310938 A1
(43) Pub. Date: Oct. 5, 2023

(54) SYSTEM AND METHOD FOR PHYSICAL FITNESS AND ATHLETICISM ASSESSMENTS

(71) Applicant: Spectrum 8 Sports, LLC, Auburn Hills, MI (US)

(72) Inventors: Kent Harold BAKER, Auburn Hills, MI (US); Paul David HURLEY, Huntington Woods, MI (US)

(21) Appl. No.: 18/126,210

(22) Filed: Mar. 24, 2023

Related U.S. Application Data
(60) Provisional application No. 63/325,492, filed on Mar. 30, 2022.

(51) Int. Cl. A63B 24/00; A63B 71/06

(52) U.S. Cl. CPC A63B 24/0062; A63B 71/0622; A63B 2225/50; A63B 2220/833; A63B 2024/0068

(57) ABSTRACT

The present technology pertains to a method, an apparatus, and a non-transitory computer-readable storage medium for fitness evaluation. An exemplary computer-implemented method includes receiving a request for benchmark data for a fitness evaluation, the request including demographic information for a participant in the fitness evaluation. The computer-implemented method further includes transmitting the benchmark data to a fitness evaluation application executed on a user computing device. The benchmark data enables the fitness evaluation application to capture performance data for the participant for the fitness evaluation, to generate a relative performance value by comparing the performance data to the benchmark data, and to present a visual indicator of the relative performance value. The computer-implemented method further includes receiving the performance data for the participant and updating the benchmark data based on the performance data.

### CROSS-REFERENCE TO RELATED APPLICATIONS

This application claims priority to U.S. Provisional Application No. 63/325,492 filed on Mar. 30, 2022, titled “Color Scale Rating System and Methods for Physical Fitness and Athleticism Assessments” and expressly incorporates the contents thereof in its entirety.

### TECHNICAL FIELD

The present disclosure relates to physical fitness and athleticism assessments and more particularly, but not by way of limiting, the present disclosure relates to a system and method for presenting a visual indicator indicating a level of performance and updating benchmark data for fitness evaluation of individuals.

### BACKGROUND

Physical education provides cognitive content and instructions that are designed to encourage psychomotor learning, and aids in the development of knowledge and behavioral skills for physical activity and physical fitness of individuals. Schools and coaching centers imparting physical education enable students to carry out day-to-day physical activities with ease, thereby instilling in them the ability and confidence to be physically active for a lifetime.

To track the performance of individuals in their fitness journey, fitness evaluations play an important role. Such assessments are pivotal in providing a baseline with respect to an individual's physical strength, endurance, agility, and capabilities. The assessments allow instructors and administrators to gather information for designing instructions to cater to individuals and/or groups, and at the same time serve as a basis for providing feedback to each individual being assessed and/or their family members.

Existing methods for conducting fitness evaluations utilize numerical and letter scoring to communicate performance ratings to individuals, family members, and/or sports teachers. Such scoring mechanisms are monotonous, especially for young students, and do not convey enough information about individual's athletic capability or skill set. Further, in some scenarios, the accuracy of results of the conventional assessments depends upon the capability of an assessor (such as an administrator, sports teacher, and the like) to capture the individual's correct data at the correct time, else it may lead to discrepant or erroneous scores. Furthermore, a comparative fitness evaluation of each individual in a group may be a challenging task owing to the disparate demographics.

### SUMMARY

According to at least one example, the present technology includes a computer-implemented method for the fitness evaluation of a participant. The computer-implemented method includes receiving a request for benchmark data for the fitness evaluation. The request includes demographic information for the participant in the fitness evaluation. The computer-implemented method further includes transmitting the benchmark data to a fitness evaluation application executed on a user computing device. The benchmark data enables the fitness evaluation application to capture performance data for the participant for the fitness evaluation, to generate a relative performance value by comparing the performance data to the benchmark data, and to present a visual indicator of the relative performance value.

The computer-implemented method further includes receiving the performance data for the participant and updating the benchmark data based on the performance data.

### BRIEF DESCRIPTION OF THE DRAWINGS

FIG. 1 illustrates an assessment event being conducted for fitness evaluation of a participant, according to an embodiment of the present disclosure.

FIG. 2 illustrates an environment in which a fitness evaluation application is executed on a user computing device, according to an embodiment of the present disclosure.

FIG. 3 illustrates components of a system for conducting fitness evaluation of a participant, according to an embodiment of the present disclosure.

FIG. 4 illustrates a configuration of a mapping tool to set up markings for assessment events, according to an embodiment of the present disclosure.

FIG. 5 illustrates placement of color-coded objects on a measurement scale, according to an embodiment of the present disclosure.

FIG. 6 illustrates a method for conducting fitness evaluation of a participant, according to an embodiment of the present disclosure.

FIG. 7 illustrates another method for conducting fitness evaluation of a participant, according to an embodiment of the present disclosure.

FIG. 8 illustrates an example of a computing system for carrying out various aspects of the present disclosure.

### DETAILED DESCRIPTION

Fitness evaluations involve various scoring mechanisms for communicating performance ratings to the individuals being assessed. Typical scoring mechanisms include numerical and letter scores that are assigned to individuals once the fitness evaluation is completed. However, such scores do not convey much information regarding metrics or references against which an individual is evaluated, such as threshold metrics, a spectrum of scores in a group, demographic specific parameters, percentile of scores, and the like. Further, the assessments for younger audiences, such as school students, are usually conducted manually using timers, stopwatches, whistles, and the like by coaches or sports teachers. Therefore, there exists a need for fitness evaluation technology that is meaningful, accurate, uses fair parameters, reduces manual intervention, and is appealing to younger audiences.

The present technology intends to improve physical fitness or athleticism assessment by configuring events for participant demographics, guiding a user or a person with instructions for conducting the assessment, recording results of assessments in a database, and presenting the results of the assessment to the user, participants, or other interested parties via a visual indication such as but not limited to color-coding. For example, the present technology may automatically generate color scores based on demographic distribution data in accordance with a benchmark such as but not limited to 95^{th} percentile as a starting point within a particular demographic population. The generation of color scores is more meaningful and motivational to participants, thus helping them to ensure that their performance during the test matches their true capability. Additionally, by visually communicating the results of assessments via color-coding as an example, the participants are more likely to be motivated to move up the color scale and improve their physical fitness and athletic capability.

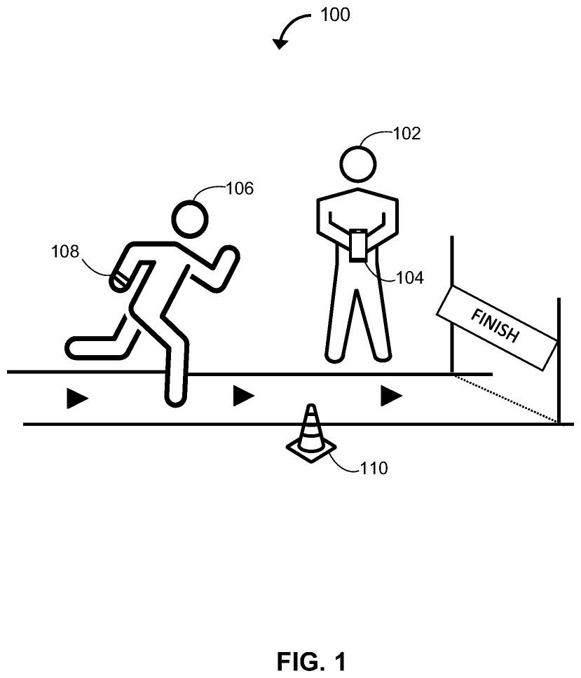

FIG. 1 illustrates an assessment event 100 being conducted for a fitness evaluation of a participant. Any person or individual being assessed for the fitness evaluation is hereinafter referred to as a “participant.” The fitness evaluation may include a single assessment event for the participant or multiple assessment events for the participant.

The assessment event 100 is a test that is conducted to measure physical fitness or athletic capability of the participant with respect to various performance parameters. The performance parameters associated with each assessment event may be related to but are not limited to reaction time, acceleration, speed, spatial awareness, balance, timing, endurance, agility, flexibility, change of direction, core strength, mental strength, hand-eye coordination, and the like. Without departing from the scope of the present disclosure, the performance parameters may be unique for some assessment events. There may be scenarios where some performance parameters are common while some performance parameters are different for some assessment events. The performance of the participant in the assessment event 100 may be captured as performance data for the participant. The performance parameters mentioned above may be used as the performance data for the participant being assessed. Alternatively, the performance parameters may be used to determine the performance data for the participant.

This disclosure is not limited to any specific number or combination of assessment events. Rather, this disclosure contemplates that any suitable number and type of assessment events may be included in each assessment. This disclosure further contemplates that assessments may include events that are specifically chosen or tailored to evaluate participants based on participant characteristics (e.g., participant age, participant gender, particularly disabilities of the participant, etc.) or for specific sports or activities. Moreover, while this disclosure generally refers to the disclosed systems and methods in the context of fitness evaluations, this disclosure also contemplates that such systems and methods may be readily adapted for competitive purposes, e.g., where participants are in competition with each other and the assessment events are used to generate scores or other comparative metrics between participants, By way of non-limiting example, in one specific implementation of an assessment for school age children, the assessment may include assessment events such as but not limited to an agility-related test (e.g., a box drill, shuttle run, or similar drill for testing a participants ability change direction and motion), a standing triple jump, a 24 meter sprint (or other speed-related test), a foam javelin throw, a sand bell throw, a beeper test, an obstacle course, and the like. This disclosure contemplates that assessment events may be performed by the participant using their own body only but may also include the use of certain equipment (e.g., weights, resistance bands, and equipment such as cycling equipment, rowing machines, and the like). Assessment events may include events designed for able-bodied individuals or may be directed to participants with certain physical, mental, or other disabilities or health conditions. For example, assessment events may be directed to participants in wheelchairs or otherwise involving the use of assistive equipment. Such assessment events may For the sake of brevity and better understanding, the assessment event 100 depicted in FIG. 1 is a sprint over a predefined distance.

The assessment events, within the context of the present disclosure, may be categorized as timed events, distance measured events, or counted events. For the assessment events, one of a time taken by the participant to cover a predetermined distance, a distance covered by the participant in a predetermined time, a distance covered during a jump or throw of an object by the participant, or a number of exercise repetitions performed by the participant either in a predetermined time or in a sequence, is measured. Since each of these parameters are indicative of the performance of the participant, these parameters may be regarded as the performance data for the participant. The timed events may be conducted in different ways such as but not limited to fixed amount or fixed time. In the fixed amount timed events, a time taken by the participant to cover a specific distance, or a set number of repetitions is measured. As a non-limiting example, a time taken by the participant to cover 24 meters or 26.2 yards distance may be measured as part of the fixed amount timed event. On the other hand, in the fixed time timed events, the distance covered, or the number of repetitions performed by the participant in a set amount of time after start is captured and thereafter used to determine a level of participant's performance. As a non-limiting example, a distance covered by the participant out of a total distance of a race (e.g., 24 meters), at a fixed time of 5 secs, may be measured as part of the fixed time timed event. Further, in the distance measured events, how far can the participant propel their body (e.g., jump) or an object (e.g., throw a javelin) in a single attempt is measured. It shall be noted that a single attempt may involve multiple motions, as, for example, in the standing triple jump. Furthermore, in the counted events, the number of repetitions performed by the participant in a sequence is measured. For example, a counted event may include a participant performing repetitions until failure or sets of repetitions to failure with defined breaks between the sets. In a non-limiting example, a beeper or beep test consists of repeated cycles of a single back and forth run between two lines, and a participant starts each cycle on an audible start signal and end of a level is indicated by an audible stop signal. The time between start and stop signals (or beeps) decreases after every predefined number of cycles (e.g., eight cycles). Each cycle ends when the participant returns to the start. The cycles continue until the participant cannot return to the starting line before the audible stop signal on any one cycle, and it is noted when the participant cannot return to the starting line before the beep signal.

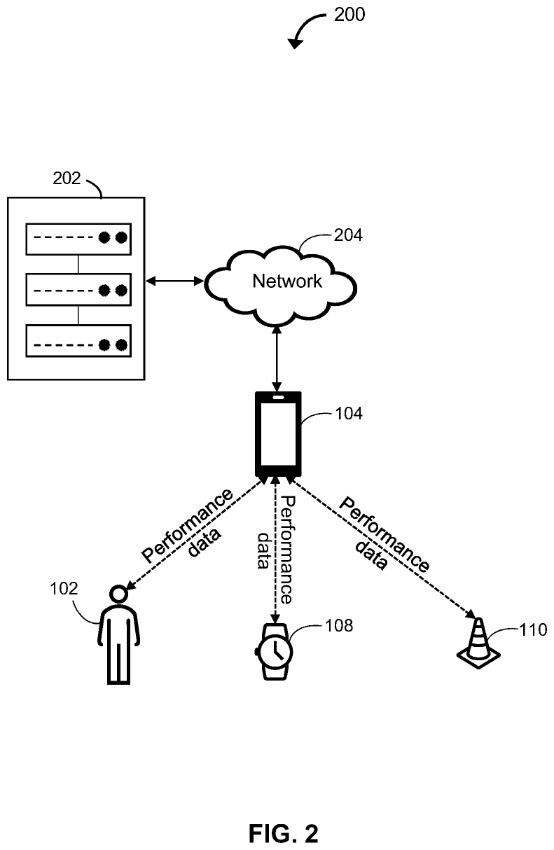

As depicted in FIG. 1, a person is involved in conducting the assessment event 100, hereinafter referred to as a “user” (shown as a user 102). The user 102 may be a sports coach, physical education teacher, a family member of the participant being assessed, an administrator, a facilitator, or any person who conducts the fitness evaluation for the participant. The user 102 may conduct the assessment event 100 using a user computing device 104. Without limitation, the user computing device 104 may be any device that is mobile, includes display capability, and can execute a fitness evaluation application on it. The fitness evaluation application may be a software application, a set of instructions, or a code, that upon execution facilitates fitness evaluation of an individual on one or more software platforms. Details regarding operations and functionality of the fitness evaluation application executed on the user computing device 104 will be explained later in FIG. 2. Examples of the user computing device 104 include but are not limited to a mobile phone, a tablet, a personal digital assistant, a wearable device (e.g., a smartwatch, fitness tracker, etc.), and other devices with built-in functionality or capability to set up and conduct the fitness evaluation.

A participant, shown as the participant 106 in FIG. 1, may be a student in a physical education class or any individual who is interested in being assessed for the fitness evaluation. Each participant may be associated with demographic information. The demographic information, for example, may include but is not limited to age, gender, education or grade level, height, weight, body mass index (BMI), presence of disability, geographic location, level of training/experience in a particular physical activity, and the like. In some scenarios, the demographic information may correspond to a range instead of an absolute value such as age range, height range, weight range, BMI range, and the like. As non-limiting examples, the participant 106 may belong to a demographic category or be associated with the demographic information such as first grade boys, second grade girls, and the like. The assessment events may be designed in accordance with the demographic categories or information of the participant 106. As an example, the user 102 may conduct the assessment for a single participant, i.e., participant 106. As another example, the user 102 may conduct the assessment for multiple participants participating in the assessment event 100.

In some embodiments, the participant 106 may be associated with device 108. Device 108 may be a wearable device worn by the participant 106 or any intelligent device that is capable of being synchronized with the fitness evaluation application executed on the user computing device 104. The synchronization may facilitate extraction of fitness monitoring data such as motion, acceleration, timing, and the like associated with the participant 106 at different points in time. As non-limiting examples, the device 108 may correspond to a smartwatch or a fitness band (e.g., a Fitbit® smartwatch) with associated fitness application, a fitness garment, a timing chip, or similar devices that enable tracking, recording, monitoring, or similar functionality for activity of the participant 106. In an embodiment, the device 108 associated with the participant 106 may include one or more built-in sensor(s) such as a motion sensor, accelerometer, pedometer, and/or other sensors for measuring the performance parameters or performance data. It shall be noted that an application executing on the device 108 may be synchronized with the fitness evaluation application running on the user computing device 104 to provide fitness monitoring data. Such fitness monitoring data may include performance data of the participant 106 that may be readily used for the fitness evaluation or may include the performance parameters that can be processed to compute the performance data of the participant 106.

Additionally, or in the alternative, one or more sensors 110 may be placed on a track or otherwise in the environment within which the assessment is to be conducted to capture performance parameters or performance data of the participant 106, and to provide the captured performance parameters or data to the fitness evaluation application executed on the user computing device 104. The one or more sensors 110 may be communicatively coupled and synchronized with the fitness evaluation application to sense and to provide performance-related information of the participant 106 to the fitness evaluation application. The fitness evaluation application, upon receiving the performance-related information from the one or more sensors 110, may correlate the performance-related information with benchmark data to provide a result of the assessment, which may include a visual indication corresponding to the results of the assessment (e.g., an alphabetical or numerical score, a color of a color-coding system, a star-based rating, etc.). In an embodiment, the one or more sensors 110 may correspond to one or more motion detectors, optical sensors, ultrasonic sensors, radio frequency identification (RFID) chips, timing chip sensors, switches, touch pads, or similar sensors that may be used to measure performance of the participant in one or more assessment events. The communication and data exchange between the fitness evaluation application running on the user computing device 104, sensors such of the device 108, and the one or more sensors 110 within the assessment environment may be facilitated by any communication network or channel without limitation.

Without deviating from the scope of the present disclosure, the type of one or more sensors 110 may vary for different types of assessment events. As an example, if the assessment event 100 is an obstacle course, then the one or more sensors 110 may include a laser or photosensor to detect when a participant crosses, travels over, travels under, or otherwise successfully navigates a particular obstacle of the obstacle course. For example, a laser beam of a laser sensor may be projected as a hurdle crossbar. Based on the performance of the participant 106 in the obstacle course, the laser sensor may provide the performance data to the fitness evaluation application, which then provides a result of the assessment of the participant 106.

As another example, if the assessment event 100 is a timed sprint over a predetermined distance, then the one or more sensors 110 may include two pressure-sensitive pads with a first pad placed at the beginning of a sprint event course and a second pad placed at the end of the spring event course. During the assessment event 100, the first pad may be activated upon detecting pressure from the participant 106 as the participant steps on the first pad (e.g., if the participant is given a running start) or upon a release of pressure from the first pad (e.g., if the participant starts the assessment on the first pad). Activating the first pad may initiate a clock or other timing element which is then stopped when the second pad is activated, e.g., by the participant stepping on and applying pressure to the second pad. The user computing device 104 may then compare the time between activation of the first pad and activation of the second pad to a suitable benchmark and present a corresponding result to the user 102 and/or the participant 106 using a suitable visual indicator. For example, the results of the assessment may be presented using a color code on a screen of the user computing device 104 or on a display in the vicinity of the sprint assessment.

As yet another example, for some assessment events, quick response (QR) readers (or similar sensors for machine-readable labels and codes) may be utilized as the one or more sensors 110 for one or more participants. For example, each participant being assessed may be uniquely identified by a QR code that may be worn on a bib or piece of clothing of the participant or may be displayed on a computing device associated with the participant 106.

In certain implementations, prior to an assessment event, the user 102 conducting the assessment event 100 may read the QR code using the user computing device 104 to initiate the assessment event 100 for the particular participant. Any performance data for the assessment event 100 subsequently collected by the user 102 may then be automatically associated with the specific participant. When the user 102 subsequently reads a second QR code associated with a second participant with the user computing device 104, the user computing device 104 may automatically begin associating any subsequently collected performance-related information with the second participant. Stated differently, QR codes or similar identifiers may be used in certain implementations of this disclosure to automatically associate collected performance information with participants in assessments and assessment events.

In addition to linking the collected data with particular participants, reading a QR code for a participant in an assessment event may also cause the user computing device 104 to automatically access demographic information and/or benchmarks for the participant such that results for the assessment event may be based on the particular participant's demographic information. Subsequently reading a second QR code for a second participant may then cause the user computing device 104 to retrieve demographic information and/or update the benchmarks used by the user computing device 104 for the second participant and to provide results for the assessment event based on the second set of retrieved information. Stated differently, QR codes or similar identifiers may facilitate automatic updating of benchmarks for participants in assessments and assessment events.

As yet another example, the one or more sensors 110 may include timing chips (e.g., RFID chips) that may be worn by participants and associated timing chip readers. Such chips and readers may be used to detect or time when a participant crosses certain thresholds (e.g., crosses start/finish lines, enters/exits a designated area) and may be configured to communicate with the fitness evaluation application executed on the user computing device 104. For example, the participant 106 may be associated with and may wear a timing chip in the form of an RFID tag or chip that interacts with a corresponding RFID reader. In response to the RFID reader detecting an RFID chip, the RFID reader may communicate a time of detection and an identifier associated with the RFID chip (and by extension the participant 106) to the user computing device 104. The fitness evaluation application may then use the received time data as performance data for determining and presenting a result of the assessment event for the participant 106.

In some embodiments, the one or more sensors 110 may be associated with or further configured to trigger some form of output device, such as a light or sound-producing device to communicate results or progress of an assessment event to the participant 106. In an exemplary embodiment, siren-type flashing lights of different colors may be placed on the track at locations corresponding to performance zones for the age group and gender of the participant 106. Each flashing light may be in communication with or activated by a laser motion detector or similar sensor configured to detect when the participant 106 passes the sensor and to activate the flashing light in response to detecting the participant 106. Accordingly, to the extent the lights are color-coded and the assessment relies on a color-based scoring system, the score for the participant 106 is the last flashing light to turn on, among the placed flashing lights, when the configured time for the assessment event 100 is up.

For light devices including attached motion detectors or other sensors to know that the time is up or illuminate colors, the fitness evaluation application running on the user computing device 104 may need to communicate, send signals, or exchange data with the sensors. Time elapsing may also be indicated as an audible beep emitted by the user computing device 104 or by another device in the vicinity or via any other means. So, for example, if the assessment event 100 is a running event or sprint where the score is based on distance travelled after a predetermined time, the color-coded score would be the last light device illuminated prior to emission of the beep or other signal.

In alternative embodiments, the one or more sensors 110 may include motion sensors that are placed on different stanchions along a track or course so that when a runner or athlete (participant 106) passes by, the motion sensor is activated. In certain implementations, the stanchions may be color-coded and may correspond to a score in a color-based scoring system. In such implementations, the motion sensors may generate the color score based on determining which colored stanchion was last passed by the runner.

In light of the various examples provided above, this disclosure contemplates that various sensors may be used to track and facilitate the recording of participant performance in addition to or as an alternative to manual recordation by the user 102. Data from the sensors may also be fed back to the fitness evaluation application executing on the user computing device 104 for recording and logging performance related data of participants. In some embodiments, the sensor data may be stored in databases either internal or external to the system 202. In other embodiments, the sensor data may be stored in log files, spreadsheets, and various other non-database formats. As a non-limiting example, the user computing device 104 may generate a CSV or log file that is provided to the back-end system 202, where the generated file may be converted and saved into a particular database.

Without limitation, each of the one or more sensors 110 described in various examples and embodiments herein may be integrated with the fitness evaluation application such that each of the one or more sensors 110 is configured to present information in alignment with the configuration of the fitness evaluation application.

In view of the foregoing, based on the information entered or selected by the user 102 on the fitness evaluation application with respect to the assessment event type, demographic information of the participant 106, and responsive instructions generated by the fitness evaluation application for the assessment event 100, the participant 106 is evaluated for the assessment event 100. A result of the assessment is determined based on performance of the participant 106 in the assessment event 100, the performance data being captured either through sensor input or manual input by the user 102. In context of the present disclosure, the result of the assessment of the fitness evaluation for the participant 106 is presented as a visual indicator of a performance value of the participant 106. In an embodiment, the visual indicator may be a color scale. Each color may be associated with a separate audio or visual cue such as a particular sound, animal, and the like to differentiate the level of performance of participants. In other embodiments, the visual indicator may be a numerical score, a letter grade, a star, other symbols, and the like.

In some embodiments, a result of the assessment related to the participant 106 may be visually indicated on the fitness evaluation application executed on the user computing device 104. In other embodiments, a result of the assessment related to the participant 106 may be visually indicated by an external device or sensor. As a non-limiting example, a computing device separate from the user computing device 104 and including a display may be utilized to provide a visual indication of the assessment related to the participant 106. In general, the supplemental computing device that may be synchronized with or otherwise be in communication with the fitness evaluation application running on the user computing device 104, may receive results from the user computing device 104, and may present visual indicators. In some implementations, the computing device may be in the form of a “timing pod” with a predefined shape (e.g., a dome shape) and which includes lights that illuminate to show one of a predefined set of colors corresponding to a participant's score or result. For example, the lights may be contained under a translucent top portion such that, when illuminated, the top portion becomes the color corresponding to the participant's score or result. More generally, the color-coded illumination of the timing pod can communicate the participant's results to the participant 106, the user 102, family members of the participant 106, and any other interested individual in the vicinity. In certain implementations, the timing pod may include stopwatch, countdown, repetition counting, or similar functionality that causes the timing pod color to change dynamically during the participant's performance of the assessment event 100. In other implementations, the computing device may be in form of a lighting tower that is located in the environment in which the assessment event 100 is conducted. The lighting tower may include one or more LED lights configured to illuminate an entire or a portion of an event space. The intensity of illumination, a timing of illumination, and/or a color emitted by the one or more LED lights may correspond to a participant's score or result and may be controlled by a processor or a controller residing internal or external to the lighting tower. Without limitation, there may be one or more lighting towers for a particular assessment event that may be configured to communicate the participant's score or result to the participant 106, the user 102, and any observer in the vicinity.

Within the context of FIG. 1, a single runner or the participant 106 may start running at a signal by the user 102, and the timing pod may be activated. In certain implementations, the timing pod may be activated remotely (e.g., using the user computing device 104) or via a switch, button, pressure pad, or similar device. For example, a start plunger may be attached to the timing pod via means such as a cord coupled to the participant such that when the participant moves, the cord is pulled to move the plunger and activate the timing pod. In an exemplary color spectrum of predefined colors, including white, pink, yellow, orange, purple, green, blue, and red with white being the lowest color on the assessment scale and red being the highest color on the assessment scale; the timing pod may display the color red upon start. At a predefined time, such as 4 seconds, the display of the timing pod may turn blue with the color display subsequently changing every predefined time interval (such as 0.5 seconds) until the last color on the spectrum i.e., white. During the course of the run by the participant 106, the timing pod may record the performance including finishing time by illuminating the correct color according to time period and grade level (or demographic information of the participant 106).

To summarize, to assess a participant, the user 102 provides information regarding the participant 106 to the fitness evaluation application executed on the user computing device 104. The fitness evaluation application accesses benchmark information for an assessment and subsequently collects performance information of the participant 106 as the participant 106 completes one or more events of the assessment. This disclosure contemplates that performance information may be input manually by the user 102, collected using functionality of the fitness evaluation application (e.g., an integrated stopwatch, repetition counter, etc.), collected automatically from various sensors and devices incorporated into the assessment event, or otherwise provided to the user computing device 104 using any suitable approach. The fitness evaluation application may then process the performance information to generate results for the participant 106, which may be subsequently presented in the form of a visual indicator on the user computing device 104 or a device (e.g., a timing pod) in communication with the user computing device 104.

FIG. 2 illustrates an environment 200 in which the fitness evaluation application is executed on the user computing device 104. FIG. 2 will be explained in conjunction with FIG. 1. For the sake of brevity, each of the elements 102, 104, 108, and 110 previously described in FIG. 1 are not explained again.

As depicted in FIG. 2, the user computing device 104 may receive performance data of the participant 106 from at least one source such as, but not limited to, the user 102 who conducts the fitness evaluation, the device 108 associated with the participant 106, and the one or more sensors 110. The performance data includes the performance parameters described previously or any data that reflects the performance of the participant 106 in a particular assessment event. The received performance data may be utilized by the fitness evaluation application running or executing on the user computing device 104 to conduct the fitness evaluation of the participant 106. For the sake of simplicity, performance data is depicted in FIG. 2 as being the type of data received from different sources such as the user 102, the device 108, and the one or more sensors 110; hereinafter referred to as “at least one data source.” However, any type of data related to fitness such as but not limited to motion monitoring data, exercise routine, route information, health related information, and the like may be exchanged between the data source(s) and the user computing device 104.

The user computing device 104 includes suitable processing circuitry to execute functions of the fitness evaluation application and to communicate with a system 202 via a network 204. In at least certain implementations, the user computing device 104 may communicate with the system 202 over the network 204 using one or more application programming interfaces (APIs) or similar interfaces that facilitate communication, data exchange, integration, and/or synchronization between the fitness evaluation application running on the user computing device 104 and the system 202. The network 204 may be any communication network, such as but not limited to the Internet, an intranet, and the like. Although the present embodiment is described with respect to the fitness evaluation being stored and executed on the user computing device 104 and supported by the system 202, the fitness evaluation application may alternatively be hosted by the system 202, e.g., as a web portal or web-based application, and accessible by a web browser or similar application executed on the user computing device 104.

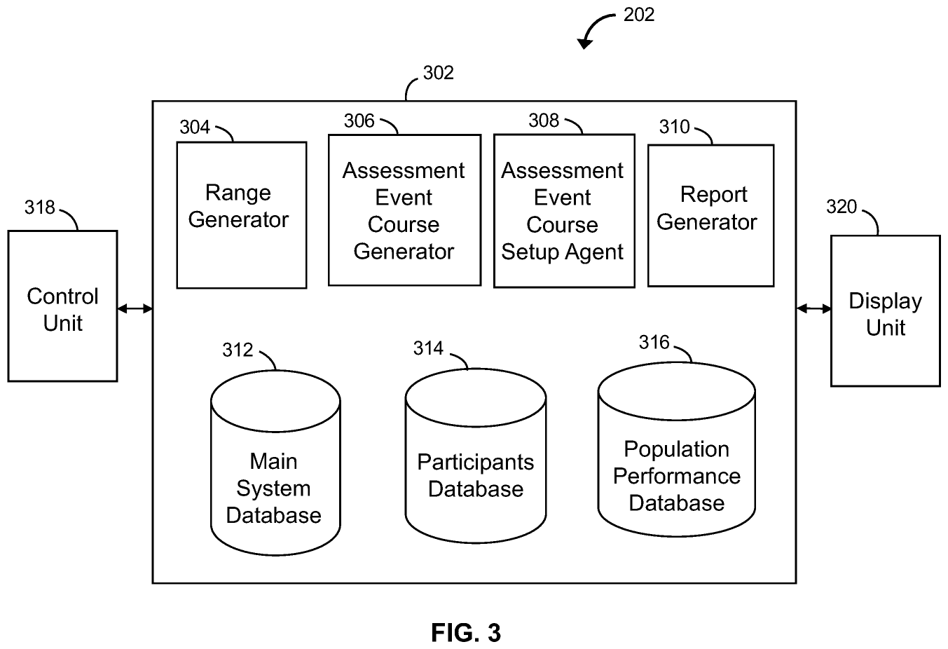

The system 202 is a back-end system that includes various modules and databases which are described in detail later in FIG. 3. The system 202 may be configured to store benchmark data, participant related data, system's operation related data, and the like. The benchmark data is data that sets a benchmark or a baseline for the fitness evaluation and, in certain implementations, may be organized, tagged, or otherwise accessible based on demographic information, such as but not limited to age, gender, school grade level, and the like. Demographic information may be further divided by geographic region. The system 202 may store benchmark data for individual assessment events, combinations of assessment events, total assessments, or any combination thereof. For example, the system 202 may store benchmark data for a sprint-type assessment event that includes average, median, or similar statistical times for multiple school grade levels. The system 202 may also store benchmark data for a complete assessment including multiple assessment events where the benchmark data may include a cumulative score based on a weighted combination of results in the assessment events making up the assessment.

The system 202 may also be configured to receive the performance data of the participant 106 from at least one data source via the user computing device 104. In scenarios where the performance data is collected from multiple sources such as the device 108 and the one or more sensors 110, the integration of the performance data from the multiple sources is facilitated by the back-end system 202 on the fitness evaluation application executing on the user computing device 104. In some embodiments, the system 202 may be a server, such as but not limited to, a database server, a web server, and the like. Due to the similar intended meaning, the terms “system,” “back-end system,” and “server” are used interchangeably throughout the disclosure.

There may be different time instances at which the performance data of one or more participants is transmitted to the system 202 by the user computing device 104 or received by the system 202. In an embodiment, the system 202 may receive the performance data for one or more participants as part of a daily, weekly, monthly, or annual update. In other words, the performance data for one or more participants may be received as part of periodic data transfer. In another embodiment, the system 202 may receive the performance data of one or more participants in real time. In yet another embodiment, the system 202 may receive the performance data as part of aggregated performance data for multiple participants in one or more assessment events. In yet another embodiment, the system 202 may receive the performance data as part of aggregated performance data for at least one of multiple participants and multiple fitness evaluations. In yet another embodiment, the performance data for one or more participants may be transmitted by respective user computing devices to the system 202 upon completion of respective fitness evaluations. Such data transmission may be referred to as event driven transmission of the performance data, where an event may be the completion of one or more fitness evaluations, a predefined time period, or any trigger warranting a data transfer to the system 202 or server.

In certain implementations, the benchmark data may be static and/or subject to manual updates by an administrator of the system 202. In other implementations, the benchmark data may be periodically updated based on communication with an external data source, such as a data source that stores and maintains fitness standards data and similar benchmarks. In still other implementations, the system 202 may dynamically update the benchmark data based on performance data of actual participants. For example, the system 202, in response to receiving the performance data, may process the received performance data in accordance with the associated demographic information of the participant 106 (or participants if the performance data corresponds to multiple participants) and stores the performance data in one or more corresponding databases. After processing and storing the performance data, the system 202 may update the benchmark data based on the received and stored performance data.

By way of non-limiting example, benchmark data for a particular assessment event or complete assessment may be based on an average or percentiles for a given demographic. Subsequent to receiving performance data for a demographic, the system 202 may recalculate the average or percentile cutoffs for the corresponding demographic based on the received performance data. So, for example, if benchmark data for an assessment and demographic included a 95%-ile cutoff of 90 points, but performance data for a recent assessment had a 95%-ile cutoff of only 80 points, the system 202 may automatically adjust the benchmark data downward (e.g., to 85 points) in response.

The benchmark data may be updated by the system 202 in real-time (e.g., in response to receiving any performance data), periodically (such as on a daily, weekly, monthly, quarterly, or annual basis based on accumulated performance data for the preceding period), based on a performance data threshold (e.g., in response to receiving performance data for 50 assessments), or any similar update condition.

As previously noted, the benchmark data may include an average score obtained by the participants with the same or similar demographic information in a specific assessment event. As another example, the benchmark data may include quantifiable measures called metrics to evaluate the athletic capability of the participants in the assessment events. The metrics may include statistics such as but not limited to maximum speed, average speed, reaction time, acceleration, agility, timing, distance covered, and the like.

In an embodiment, the system 202 may receive performance data for one or more participants corresponding to different demographics for different assessment events. After receiving the performance data, the system 202 may update the benchmark data, e.g., as an average of scores obtained by each participant against each demographic.

As previously noted, benchmark data for a given demographic may be updated based on performance data obtained for the demographic. In at least certain implementations, benchmark data for a demographic may also be updated based on performance data for a different demographic. For example, a score or other performance data for an assessment event for a participant in fourth grade may be used to update benchmark data for the assessment event for second grade participants. In certain implementations, results may be scaled or otherwise adjusted across demographics to account for differences between the demographics. Using the previous example, the performance data for the fourth grade participant may be adjusted down by 10% when applied to update the second grade benchmarks to account for physical differences between children in the two grade levels.

As a non-limiting example, referring to FIG. 1, consider the assessment event 100 to be a running event and the demographic information entered by the user 102 on the fitness evaluation application residing on the user computing device 104 indicates that the participant 106 is a male in the second grade. In this case, the fitness evaluation application, based on the assessment type and the demographic information entered by the user 102, may capture the performance data of the participant 106 by comparing the performance data to the benchmark data. The benchmark data corresponding to males in the second grade may be received from the system 202 in real time by the fitness application or may be stored on the user computing device 104 in a manner accessible by the fitness evaluation application to generate a relative performance value of the participant 106 based on the comparison and corresponding to a result achieved by the participant 106. After generating the relative performance value, the fitness evaluation application may present an indication such as but not limited to a visual indication of the relative performance value/result. The captured performance data of the participant 106 may be transmitted to the system 202 either in real-time as the performance data is collected or subsequently as part of a broader data set transmitted to the system 202. The system 202 may then update the benchmark data for males in the second grade (or other demographic for which the performance data is relevant or to which the performance data can be correlated) based on the received data. The updated benchmark data may then be used for subsequent fitness evaluation of participants. Stated differently, the benchmark data can be continuously updated by the system 202 as performance data is collected and processed.

Accordingly, in the disclosed embodiments, the performance data of one or more participants is captured by the fitness evaluation application and fed back to the back-end system 202. Such a feedback mechanism allows the system 202 to update or adjust, in turn, the benchmark data based on the performance data for future assessments of participants. The continuous update in the benchmark data ensures better accuracy of scores for assessments, fairer assessments that better reflect performance by participants in certain demographics, and dynamically adjust benchmark data as characteristics of demographics change.

Without limitation, it shall be noted that multiple participants may participate in the assessment event 100 with each participant being assessed using a single instance of a fitness application executed on a single user computing device 104. Alternatively, any subset of participants (including each individual participant) may be assessed using respective fitness evaluation application executed on corresponding user computing devices. In such a scenario, the performance data of each participant is fed into the system 202 (or server) via respective data sources, including sensors, associated with the participant or subset or participants. Among other benefits, such implementations may facilitate virtual events or assessments in which multiple, geographically separated participants can take part in a common assessment or competition. As an example, multiple participants may participate in the assessment event 100 virtually from remote locations through their respective devices, and sensor data associated with their respective wearable devices or sensors may be updated against their respective participant's names (or other identifier) to facilitate performance assessment, fitness evaluation, or competitive performance of each participant. In these examples, user computing devices associated with each participant or user may be coordinating with each other through the common fitness evaluation application running on each user computing device.

In certain implementations, the present technology utilizes the back-end system 202 and the fitness evaluation application to form a feedback loop. The feedback loop facilitates retrieval of the benchmark data from the system 202 to conduct the assessment or fitness evaluation of the participant 106 via the fitness evaluation application, and feeding back the result of the assessment to the system 202 to update the benchmark data for future assessments. The feedback mechanism ensures up-to-date data for comparing the respective performances of participants, resulting in scores that indicate the true potential of each participant with respect to peers or in a group. Further, the back-end system 202 enables automatic evaluation of assessments using different sensors disclosed in various embodiments throughout the disclosure. As an example, the performance data for the participant 106 may be collected via at least one sensor (wearable and/or external) that is coupled or synchronized with the fitness evaluation application. Based on the data exchange and coupling between the at least one sensor, the fitness evaluation application, and the server 202, a result of the assessment may be displayed automatically either on the fitness evaluation application executing on the user computing device 104 or on a display portion of any coupled external device or sensor. This approach reduces the human intervention in the assessment process, thereby considerably reducing chances of error or bias from facilitators, administrators, or coaches conducting the assessments.

FIG. 3 illustrates components of the system 202 for conducting a fitness evaluation of a participant. FIG. 3 will be explained in conjunction with FIG. 2 and FIG. 1.

For the sake of better understanding, different components of the system 202 are explained as being implemented on a same physical device. However, without limitation, different components may be implemented across different physical devices.

In an embodiment, the system 202 may have a single processor or multiple processors to carry out various functionalities related to fitness evaluation and could be implemented in different ways in various embodiments. The different ways include, by way of example and not of limitation, digital or analog processors such as microprocessors and Digital Signal Processors (DSPs), controllers such as microcontrollers, software running in a machine, programmable circuits such as Field Programmable Gate Arrays (FPGAs), Field-Programmable Analog Arrays (FPAAs), Programmable Logic Devices (PLDs), Application Specific Integrated Circuits (ASICs), any combination thereof, and the like.

Further, the system 202 may utilize multiple memory elements either shared or separate for processing the participant or event related data. It should be noted that the process for conducting the fitness evaluation of each participant may be performed by one or more processors associated with the system 202 at same or different locations.

A software configuration of the system 202 includes a system processing unit 302 to facilitate major processing operations at the back-end of the system 202 to render results at one or more front-end devices. The system processing unit 302 includes different components or modules that enable the fitness evaluation application to conduct the fitness evaluation for participants. Each module may support one or more graphical user interfaces (GUIs) that are presented to the user 102, the participant 106, or others via the fitness evaluation application or related applications. It will be apparent to a person with ordinary skill in the art that GUIs may be presented as web pages by the server 202 via a website or web portal that may be accessible over the network 204 using a web browser on the user computing device 104. Typically, a GUI may include graphical elements, visual indicators, and/or text elements to convey information and represent actions that may be taken by the user 102 or any person using the fitness evaluation application. Upon receiving an input from the user 102, the GUI elements may change color, size, and/or visibility. The graphical elements may include one or more of: icons, cursors, radio buttons, check boxes, dialog boxes, menus, sliders, windows, toolbars, and the like. As illustrated in FIG. 3, the modules of the system processing unit 302 may include a range generator 304, an assessment event course generator 306, an assessment event course setup agent 308, a report generator 310, a main system database 312, a participants database 314, and a population performance database 316.

Further, the system processing unit 302 is coupled to a control unit 318 and a display unit 320 to conduct the operations involved in the fitness evaluation of individuals. The foregoing components and various alternatives are described in the subsequent paragraphs in further detail and by way of various illustrative examples.

In one specific implementation, the system processing unit 302 may utilize at least three types of databases to store data, namely the main system database 312, the participants database 314, and the population performance database 316, each storing different types of data. Although the disclosure refers to data storage entities as databases in one or more implementations, it will be apparent to a person with ordinary skill that the databases described herein may refer to datasets, without limitation. The datasets may include a collection of related sets of information that is treated as a single unit by a processor or a computer. In some embodiments, each dataset may correspond to one or more database tables. The main system database 312 may be configured to store information needed for system access authorization and authentication, information required for different modules such as the range generator 304, the assessment event course generator 306, and the report generator 310, and information needed for server or system operations. The main system database 312 may also include data pertaining to users, facilitators, organizations, groups, events data, and other relevant assessment data. The participants database 314 may be configured to store information on individual participants and their performance or assessments in the assessment events. Specifically, all the information related to the participants is stored in the participants database 314.

The population performance database 316 may be configured to store population distribution data for different demographics. As described previously with respect to FIG. 1, the participant's performance data for each assessment event is captured along with the demographic information associated with the participant 106. For example, the population performance database 316 may provide specific population distribution data of a specific demographic (such as second grade boys) for a specific assessment event (such as sprint), and such data can be readily used by other modules of the system processing unit 302 to execute their respective functions. Further, the population performance database 316 may be configured to store analytical data related to performance of participants or aggregated results of participants that aid in conducting the fitness evaluations. In certain implementations, the data stored in the population performance database 316 may include the benchmark data. Alternatively, the population performance database 316 may include data from which the benchmark data may be calculated or otherwise derived. In either case, the benchmark data may be stored in the population performance database 316 or may be stored in a separate benchmark data source or database.

In some embodiments, a request for the benchmark data is received by the system processing unit 302 from the user computing device 104 for the fitness evaluation. The benchmark data, as previously described in FIG. 2, may be retrieved from the population performance database 316 or may be dynamically generated from the population distribution data stored in the population performance database 316. However, without limitation, the participant related data stored in the participants database 314 may be used in conjunction with the population distribution data stored in the population performance database 316 to retrieve or generate the benchmark data. Within the context of the present disclosure, the system processing unit 302 may dynamically generate the benchmark data as and when the population distribution data is added or updated. In alternate implementations, the benchmark data may be locked or kept constant for a particular assessment event. In a non-limiting example, a separate instance of benchmark data may be created or stored by the system 202 or in the user computing device 104 for the particular assessment event. The benchmark data, created or stored in such a manner, may be utilized for assessing one or more participants who participate in the particular assessment event corresponding to a certain demographic or different demographics. In another non-limiting example, for an ongoing assessment of a participant, the system 202 may generate or the user computing device 104 may retrieve certain benchmark data based on the demographic information of an assessed participant (e.g., participant 106), and the system 202 may preclude any changes to the benchmark data until the assessment is complete. In other words, the benchmark data once generated or retrieved for a particular assessment may not be updated until the participant 106 has been assessed for the assessment event 100. Meanwhile, without limitation, the system 202 may continue to receive performance data for other participants with the demographic information same (or different) as the participant 106 being assessed, but the corresponding update in the benchmark data may occur only after the ongoing assessment is completed. In yet another non-limiting example, the benchmark data may not be updated until a particular day or time when assessments are unlikely to occur such as but not limited to midnight, on holidays, and other events.

The benchmark data may serve as a threshold or basis for calculating a relative performance value of the participant 106 after the participant 106 has finished the attempt in the assessment event 100. The relative performance value is computed by comparing the performance data of the participant 106 with the benchmark data. Since the population performance database 316 contains the population distribution data of specific demographics for specific assessment events, therefore the system processing unit 302 may be configured to use a predefined percentile score as the benchmark data for assessing the participants without limitation.

In some embodiments, 95^{th} percentile score, as an example, may be utilized as the benchmark data for computing the highest assessment score, and 5^{th} percentile score may be utilized as the benchmark data for computing the lowest assessment score. The 95^{th} percentile score may be continuously updated based on the updates in the population distribution data and demographics being compiled for each assessment per participant. In another embodiment, the benchmark data may include metrics for one or more assessment events included in the fitness evaluation. In yet another embodiment, the benchmark data may include a metric corresponding to an aggregated score for one or more assessment events included in the fitness evaluation. As an example, a participant may have participated in multiple assessment events with a corresponding score being assigned for each assessment event. In such a scenario, an aggregated score for the performance of the participant in multiple assessment events may be used as the benchmark data. In fact, without limitation, in some embodiments, an aggregated score for the performance of each participant in the multiple assessment events with the same demographic category may be considered as the benchmark data.

It will be apparent to a person with ordinary skill in the art that any type of demographic information may be associated with a participant for comparison with the benchmark data to arrive at a relative performance value of the participant 106. As an example, the system 202 may compare an aggregated or average score of participants in one geographical location with the performance data of the participant 106 in another geographical location. In case of young participants, as another example, an aggregated or average score of participants in one or more groups may be compared with the performance data of the participant 106 in another one or more groups.

Although the databases described above as part of the system processing unit 302 have specific functionality and are shown to function independently from each other, however, all the three databases may be combined to form a single database or be partially combined to store data and facilitate data exchange seamlessly through the network 204, as disclosed in FIG. 2.

The range generator 304 may be configured to use different methods based on the population distribution data, from the population performance database 316, to determine the benchmarks or ranges for an assessment event. The benchmarks or ranges may correspond to color ranges, as an example, where bounds of each color range for a particular demographic category are determined by the range generator 304. However, without limitation, the benchmarks or ranges may correspond to other ranges that may associate alphabets, numbers, or combinations thereof to specific ranges of performance in the distribution. Accordingly, instead of color-coded indications, the results of assessments may be provided in form of ratings or scores depicted as alphabets, numbers, star-based ratings, or combinations thereof. In embodiments where a result of an assessment of the assessment event is communicated in a color-coded manner, the system 202 may support various color schemes. However, to understand the disclosure in a better manner, a color scheme of eight colors and associated rankings will be used as an example throughout the disclosure. The eight colors may include red, blue, green, orange, purple, yellow, pink, and white, with red being the highest score assessment and white being the lowest score assessment. The system 202 may deploy different methods, as set forth below, to use the population distribution data to determine the bounds or width of each color range corresponding to a certain demographic for a certain assessment event.

A first method, for example, to determine the width of color range in the exemplary color scheme described above may utilize the 5^{th} and 95^{th} percentile scores that may either be available within the system 202 or calculated from the population distribution data. Due to usage of 5^{th} and 95^{th} percentile scores, the first method may be referred to as 5^{th}-95^{th} percentile method. The first method may assign a score of red to results on an assessment that falls above the 95^{th} percentile and a score of white to results on an assessment that is below the 5^{th} percentile. Scores between the 95^{th} and 5^{th} percentiles may be divided into six intervals of equal length. For instance, if the first method is deployed for a demographic with a normal distribution, the frequency of occurrences for an assessment may have following percentages for the color intervals: white at 5%, pink at 9%, yellow at 16%, orange at 21%, purple at 21%, green at 16%, blue at 9%, and red at 5%.

In a second method, for example, the system 202 may divide a numerical score for the 95^{th} percentile by 16 and set each color range under red (i.e., the top range) to the value obtained after division. Due to division by 16, the second method may be referred to as 1/16^{th} interval method. When the second method is used, any participant's attempt that lies in the first half of the course may fall below the white interval (i.e., the lowest range) since all the colored ranges may be in the second half of the assessment course. Thus, any score that falls below the white interval may be assigned a score of white. It shall be noted that the second method may be beneficial when the lowest possible score of a participant for the assessment event is zero. Therefore, if the population statistic is a measure of time, then the population statistic may need to be converted to speed by dividing, for example, the distance of the event by the time taken by the participant to cover the distance because the slowest time for a participant to run an event is theoretically infinity. With the second method, the percentages of participants that fall in each color interval are expected to be slightly different than those identified with the first method for demographics with a normal distribution of performance. While the top color interval (i.e., the red zone in the exemplary color scheme) would be the same for both the first and second methods at 5%, the breakdown of the remaining colors may depend on the mean-to-standard deviation ratio. However, the second method may offer convenience to the facilitator or administrator in the setup of assessment events.

In a third method, for example, the system 202 may divide the numerical score for the 95^{th} percentile by eight and set each color range under red (i.e., the top range) to the value obtained after division. Due to division by eight, the third method may be referred to as ⅛^{th} interval method. Generally, with the third method, very few participants may fall in the lower color ranges for some assessment events since the participants are so close to the starting line or point.

Therefore, each of the methods, as described, may be utilized by the range generator 304 to determine the width of each color range that is further utilized by other modules of the system 202 to conduct the assessments. However, the scope of the disclosure is not limited to color-coding based assessments and may be extended to other forms of ratings or scores.

The assessment event course generator 306 may be configured to define a configuration for each assessment event corresponding to a particular participant's demographics. The configuration corresponds to a layout on the field or otherwise to conduct the assessment event. In an embodiment, the configuration for each assessment event may be adjusted or optimized as additional demographic and performance information is collected for one or more participants and fed back into the system 202.

Once the configuration or layout is determined for the assessment event by the assessment event course generator 306, the assessment event course setup agent 308 may be configured to guide a user through the steps for placing markers and other items needed for the assessment event course. For example, the assessment event course generator 306 may provide information about how to lay out various colored objects, such as but not limited to colored cones and flashing lights, to mark intervals or targets for the assessment event course. Therefore, after the bounds or ranges (e.g., color ranges) for a particular demographic and a particular assessment event are determined by the range generator 304, the configuration for the course may be generated by the assessment event course generator 306, and the instructions may be provided to the user 102 or administrator for the placement of markers for the course by the assessment event course setup agent 308. The information provided to the user 102 for setting up the fitness evaluation course or a specific type of the assessment event 100 may be referred to as fitness evaluation course setup information. In an embodiment, the fitness evaluation course setup information may be transmitted to the system 202 or server by the user computing device 104 in response to the request for benchmark data. Alternatively, the fitness evaluation course setup information may be transmitted by the user computing device 104 to the system 202 or server as a separate request for retrieving the fitness evaluation course setup information. In response to the transmitted request, the fitness evaluation application may be adapted to receive and present the fitness evaluation course setup information to the user 102 of the user computing device 104.

The report generator 310 may be configured to compile, generate, and present the performance data for an individual or group of participants. A variety of reports may be generated by the report generator 310. By way of non-limiting example, a report may be generated on an individual, group (e.g., school class, team), demographic (e.g., second graders), or other similar basis. The report may be for a specific or a broader multi-event assessment. The results presented in the report may also include results for a most recent event/assessment, one or more historic events/assessments, or a combination thereof, including corresponding trends, changes, and the like. The report may also include various statistical summaries, comparisons to and information regarding other participants, comparison to and information regarding benchmarks, and any other useful information for interpreting and analyzing the report.

The generated reports indicating the performance of the individual or group of participants may be utilized to identify the strong and weak areas of each participant, and accordingly, efforts may be taken to improve the performance and fitness capability of the assessed participant 106. The reports may be generated on a daily, weekly, monthly, or yearly basis without limitation. In certain implementations, the generated reports may be accessed through the fitness evaluation application running on the user computing device 104, any device associated with the user 102, or the participant 106. In other implementations, the generated reports may be accessed through a web portal via a web browser on the user computing device 104 or any device associated with the user 102 or the participant 106. In further implementations, the generated reports may be communicated through email(s) to one or more email addresses entered by the user 102 or one or more default email addresses that may be associated with the user 102, the participant 106, and/or any other person interested in viewing the reports. In further implementations, the generated reports may be sent to respective devices associated with the user 102, the participant 106, or any other interested person via short messaging service (SMS) or any other text-based messaging service. In further implementations, the generated reports may be rendered on an external display in the environment of the assessment event 100, where the external display may be synchronized with the fitness evaluation application to display the reports. In each of these implementations, the reports indicative of the performance of one or more participants may be presented in a predefined manner, for example, as entries on a leaderboard.

The control unit 318 may be configured to provide user access to the event setup, event management, and data collection functions. All the control operations carried out on front-end of the fitness evaluation application running on the user computing device 104, as disclosed in FIG. 2, may be handled by the control unit 318. As an example, the user 102, while conducting the assessment for the participant 106, enters and selects specific information on the fitness evaluation application. The entered and selected information is received by the fitness evaluation application on the user computing device 104 using the control unit 318. If the user 102 is provided access to use the fitness evaluation application for conducting the fitness evaluation, then the control unit 318 facilitates assessment event setting up, management, and collection of data or information entered by the user 102 with respect to participant(s). Due to the communicative coupling of the control unit 318 with modules of the system processing unit 302, data exchange between the modules and the control unit 318 is seamless. In an embodiment, the control unit 318 may be associated with the user computing device 104 on which the assessment is being conducted. In another embodiment, the control unit 318 may be associated with any external device or sensor communicatively coupled to the user computing device 104. In yet another embodiment, the operations of the control unit 318 may be performed in a distributed manner or shared among the server 202, the user computing device 104, and/or the external device or sensor.

The display unit 320 includes suitable hardware, software, firmware, or combinations of hardware, software, and/or firmware to present GUIs that enable assessment of participants through the fitness evaluation application, present setup instructions for setting up an assessment event, present results of assessments, present reports generated through the report generator 310, and present other information related to the assessment. The information displayed on the user computing device 104, while conducting the assessment using the fitness evaluation application, is facilitated by the display unit 320. The display unit 320, as an example, may correspond to a display screen of the user computing device 104 on which the assessment is being conducted. As another example, the display unit 320 may correspond to a display portion of any device (such as timing pod) or sensor (such as color-coded sensors) which is capable of presenting the visual indication based on a result of the assessment.

In certain embodiments, the display unit 320 may be configured to provide, for example, color-coded visual information or audio information to participants, observers, and users during assessment events. However, without limitation, the information may be provided to the participants, observers, and users using ways other than color-coding.

As disclosed earlier with respect to FIG. 1, most assessment events can generally be categorized as timed events, distance measured events, or counted events. Each of these types of assessment events may be conducted for the participants using the components of the system 202 described herein. To conduct a particular type of assessment, the user 102 is generally required to set up the assessment event 100. Steps for setting up and conducting each of the foregoing types of assessment events may be different, and are described as set forth.

In an embodiment, to set up the timed event, the user 102 may first select the assessment event to be conducted on the fitness evaluation application running on the user computing device 104. The timed event may be a fixed amount timed event where a time taken by the participant 106 to cover a fixed amount of distance or repetitions is measured, or may be a fixed time timed event where a distance covered or a number of repetitions of a particular activity performed by the participant 106 in a fixed time is measured. The user 102 may be required to select either one of the fixed amount or fixed time timed event to configure the type of timed event.

Subsequent to the selection of the assessment event, the user 102 may enter or select a participant demographic group associated with the participant 106 for the assessment. The participant demographic group may include a combination of gender and grade level for younger participants, for example, second grade boys, second grade girls, third grade boys, and the like. However, without limitation, the participant demographic group may pertain to one or more of height, weight, BMI, presence of disability, geographic location, and other statistical factors that define a population. In accordance with the information selected or entered by the user 102 (e.g., on a dashboard of the fitness evaluation application), the system 202 may calculate an optimum layout using the assessment event course generator 306 based on benchmark data for the participant demographic group and the ranges determined by the range generator 304, and guide the user 102 through the use of layout tools to place the markers for the timed event using the assessment event course setup agent 308. As an example, placing the markers may include marking start and finish lines, placing colored markers for intervals, and the like. In some embodiments, to streamline assessment execution, the system 202 may recommend combining specific demographics on a particular course layout like first and second grade boys may use the same course layout with third and fourth grade girls, as an example.

The user 102 may next conduct the timed event for the participant 106. First the steps for conducting the timed events with fixed amount will be described followed by the steps for conducting the timed events with fixed time.

Initially, to begin conducting the timed events with fixed amount, the user 102 may select the assessment to be performed and the participant demographic group. After or along with the selection or entry of the assessment type and the participant demographic group, in some embodiments, participant identity information, for example, a name or a unique ID of the participant 106 may be entered manually by the user 102 on a user interface (UI) of the fitness evaluation application. Without limitation, the participant identity information may be entered in real-time at the time of assessment, or previously entered into the system 202 (or participants database 314) as part of a periodic data upload or ad-hoc data upload of participant related data. In scenarios where the participant identity information is previously entered, the user 102 may select a particular participant, for example, from a list of participants populated on the UI of the fitness evaluation application. In alternate embodiments, the participant identity information may be received by the system 202 or the user computing device 104 automatically from one or more of: the device 108 associated with the participant 106, the one or more sensors 110, or any sensor in the environment in which the assessment is conducted. Hence, there may be scenarios when there is no entry or selection of the participant identity information, and the participant 106 may be identified via sensor input into the system 202 or the fitness evaluation application. After the selection or entry of appropriate information on the UI of the fitness evaluation application running on the user computing device 104, the participant 106 is required to line up at the start marker that had been placed while setting up the assessment event. In some scenarios, the initiation of the timed event may be manual (e.g., initiated by the user 102), while the initiation may be captured automatically in other scenarios. As a non-limiting example of the manually initiated scenarios, after the participant 106 has lined up, the user 102 may select a UI element, such as a start button, that indicates an initiation of the assessment to the system 202 using the control unit 318. In response to the selection, the system 202 may produce an audio signal for the participant 106 to start an attempt for the timed event and a stopwatch in the system 202 is initiated. The audio signal may have, for example, a “go” sound to indicate to the participant 106 to start the physical activity. Although audio signal and stopwatch are indicated as initiation mechanisms for the timed event that are triggered in response to manual selection of buttons on the UI of the fitness evaluation application, however any other means may be utilized to perform same functionality.

Further, in certain scenarios, while the participant 106 attempts the physical activity associated with the timed event, a start time or performance-related parameters associated with the participant 106 may be captured automatically by devices or sensors (e.g., device 108, one or more sensors 110, etc.) in the environment in which the assessment is conducted. As a non-limiting example, the device 108 associated with the participant 106 may correspond to a smartwatch, a fitness band, or a timing chip that detects a start timing of the attempt by the participant 106 via embedded or in-built sensors (e.g., accelerometer, gyroscope, pedometer, etc.). The embedded or in-built sensors may detect acceleration, frequency, duration, intensity, and patterns of movement associated with the participant 106, and all the sensed information may be collected and condensed to generate the performance-related parameters or an overall reading for the participant 106. The detected information associated with the participant 106 may be communicated to the fitness evaluation application for subsequent processing in the assessment. As another non-limiting example, the one or more sensors 110 placed on track or otherwise located in the environment in which the assessment is conducted, may automatically capture a start time at which the participant 106 starts the attempt using different sensing technologies. The captured start time along with other performance parameters sensed at that time instant, may be communicated to the fitness evaluation application. The one or more sensors 110 may correspond to one or more of laser/photosensor, pressure-sensitive pads, a QR reader sensing a QR code associated with the participant 106, a motion sensor/detector, and any sensor capable of monitoring and recording performance-related information of the participant 106. The operations or working methodologies associated with different examples of the device 108, the one or more sensors 110, or other external sensors/devices, as described previously in the description of FIG. 1, are not repeated again for the sake of brevity but are applicable herein for conducting the assessments for different types of assessment events such as the timed events, the distance measured events, and the counted events.

The captured start time or performance-related information associated with the participant 106 may be received by the fitness evaluation application on the user computing device 104 from one or more of: the device 108, the one or more sensors 110, or other sensors/devices; and linked to the participant 106 either manually by the user 102 or automatically using the participant identity information received from the respective sensor/device. As a non-limiting example, the user 102 may detect the performance-related information being received, at the time of assessing the participant 106, on the fitness evaluation application executing on the user computing device 104; and the user 102 may manually input the received data (such as start time) against a name of the participant 106 being assessed on the fitness evaluation application. As another non-limiting example, the participant 106 may be associated with the captured performance-related information by receiving the participant identity information through an ID tag (e.g., an RFID tag) associated with or worn by the participant 106. In yet another non-limiting example, the participant 106 may be associated with the captured information by receiving the participant identity information through scanning a QR or bar code that includes embedded information to uniquely identify the participant 106. Without limitation, any other similar identification means may be utilized to associate the sensor-collected data with the participant 106 on the fitness evaluation application, to aid in the fitness evaluation of the participant 106.

In certain implementations, an ongoing performance of the participant 106 during the attempt may be indicated in real-time to the user 102 or any interested person through visual or non-visual indications. In an embodiment, the system 202 may count down using the control unit 318, and display a visual indication (e.g., color for each corresponding interval) using the display unit 320 as time progresses during the participant's attempt in the timed event. In accordance with the exemplary color scheme, the system 202 may start displaying red i.e., highest assessment color upon start. Subsequently, the system 202 may turn the displayed color to blue when the participant's timing would register blue if the participant 106 was at the finish line, and so on until white is displayed when the participant's timing would be in the last interval. As an example, red may be displayed corresponding to the 95^{th} percentile interval, and white may be displayed corresponding to the 5^{th} percentile interval. The methods to determine percentages for the color intervals or generation of width of color ranges will be described in subsequent paragraphs. In another embodiment, a time elapsed from the start time of the assessment event 100 may be captured by the system 202 or the fitness evaluation application, and subsequently associated dynamically with an alphabetical/numerical score or a star-based rating based on the benchmark data. The associated scoring or rating may be displayed using the display unit 320 in incremental or decremental manner (e.g., starting from the highest score or rating and incrementing/decrementing based on benchmarks/thresholds) as the participant 106 performs the attempt, to communicate the participant's ongoing performance to the participant 106, the user 102, or any interested person. It should be noted that the ongoing performance of the participant 106 may be communicated via a display of the user computing device or any external device through dynamically generated visual or non-visual indicators (e.g., via audio signals).

Once the participant 106 reaches the finish line, in some embodiments, the user 102 may manually select an element on the UI of the fitness evaluation application indicating the end of the timed event for the participant 106. The user may press, for example, a stop button using the control unit 318. After the user 102 has indicated the end of the assessment for the participant 106, the system 202 may produce a finish audio signal on the fitness evaluation application running on the user computing device 104. In other embodiments, the end of the assessment or the timed event may be detected automatically using sensors, and the sensed data may be communicated to the user computing device 104 due to synchronization or coupling between the respective sensor and the user computing device 104 through suitable network. Without departing from the scope of the disclosure, the sensors or devices used for sensing the start time or capturing performance-related data may be utilized for sensing the end time and related performance parameters as well. Therefore, analogously, the end time may be detected via one or more of: the device 108, the one or more sensors 110, or other sensors/devices in the environment in which the assessment is conducted. The examples previously described for each of these sensors/devices during the start time detection of the participant 106 are applicable for the end time detection of the participant 106. The fitness evaluation application on the user computing device 104, upon receiving the captured end time and related performance parameters from respective sensors/devices, may link the participant 106 with the captured information. The linking may happen either manually by the user 102 or automatically using the participant identity information received from the respective sensor/device in a manner previously described during the start time detection. In certain implementations, the start time and the end time detection may be performed by same one or more sensors/devices, while in other implementations the start time and the end time detection may be performed by different one or more sensors/devices. Additionally, the sensing of the performance-related data associated with the participant 106, in the disclosed embodiments and implementations, may be performed by respective one or more sensors/devices at the start of the attempt, during different time intervals of the attempt, and at the end of the attempt without any limitation.

In certain scenarios where the performance-related data sensed by the one or more sensors or devices, as noted above, is received in different formats by the fitness evaluation application, then the system 202 may be capable of reading, processing, and/or converting the received data in a uniform format for conducting the assessment for the participant 106. In other scenarios where same performance-related data is sensed by multiple sensors or devices, then the system 202 may be capable of prioritizing data from one sensor/device over another sensor/device based on a priority assigned to each of the sensors or devices in the environment in which the assessment is conducted. The prioritization may be performed, as an example, during the synchronization or coupling of respective sensors or devices with the fitness evaluation application and may be based on capability of respective sensors or devices. However, without limitation, the priorities may be assigned dynamically or in real-time to each sensor or device using the intelligence (e.g., using artificial intelligence or machine learning algorithms) embedded within the system 202.

After the participant's performance-related data (or broadly the performance data) is captured by the fitness evaluation application on the user computing device 104 either manually by the user 102 or automatically by the one or more sensors/devices, the system 202 at the back-end may use the population distribution data or demographic distribution data, from the population performance database 316, to retrieve the benchmark data. As previously noted, the benchmark data is used as a basis to generate a result of the assessment by comparing the performance data of the participant 106 with the benchmark data. The generated score, as an example, may be then displayed by the display unit 320. The generated score, in some embodiments, may correspond to visual indication such as different colors displayed for different performance levels. The generated score, in other embodiments, may correspond to audio indication such as different audio signals produced for different performance levels. The generated score, in further embodiments, may correspond to a combination of visual and audio indication being generated for different performance levels. After the result of the timed event is displayed or communicated to interested parties such as the user 102, the participant 106, and/or observers, the participant's score may be stored in the participants database 314.

Prior to conducting the timed events, one or more participants that are to be assessed for the fitness evaluation may be provided instructions for the assessment in suitable form (e.g., via verbal, written, visual, and/or audio means) and a scoring chart that details a scoring mechanism may be displayed.

Further, to conduct the timed event with fixed time assessments, in certain embodiments, the user 102 may select or enter the assessment type, participant identity information (optionally), and participant demographic like the fixed amount timed event. After the selection or entry of relevant information, the participant 106 may line up at a start marker. The assessment event may be initiated by manual selection of a UI element (e.g., start button) on the fitness evaluation application by the user 102. In response to the selection, the system 202 may produce an audio signal (e.g., “go” audio signal) for the participant 106 to start the attempt for the timed event, and accordingly a stopwatch in the system 202 may be initiated. During the attempt, the system 202 may produce another audio signal, for example, at a set time for measurement. The set time may be generated by the system 202 using the demographic distribution data from the population performance database 316. After the audio signal indicating the set time is produced, the user 102 may note a marking reached by the participant 106 (e.g., color mark) when the finish audio signal was presented. The noted color mark may be selected by the user 102 using the control unit 318.

In other embodiments, instead of manual input or selection by the user 102, the start and end timing of the timed event with fixed time may be automatically detected by one or more sensors/devices in the environment in which the assessment is conducted. The examples of the one or more sensors/devices and corresponding sensing technology previously described for measuring and detecting the completion of timed event with fixed amount are applicable for measuring and detecting the completion of timed event with fixed time. The fixed time timed event measures performance of the participant 106 until a set time, which is generated based on the benchmark data or the demographic distribution data. Therefore, in some embodiments, the one or more sensors/devices may be preconfigured or synchronized with the fitness evaluation application on the user computing device 104 to detect motion of the participant 106 for a set duration corresponding to the set time of the fixed time timed event. As an example, the fitness evaluation application may cause retrieval of the benchmark data or the demographic distribution data from the population performance database 316 of the system 202 to compute the set time for the timed event with fixed time, and in turn, may cause configuration of the respective one or more sensors/devices to capture performance-related data for the computed set time. In alternate embodiments, the one or more sensors/devices may automatically detect that the participant 106 has attempted the physical activity for the fixed time timed event for a predefined duration based on sensing the start and end timings using the underlying sensing technology. As an example, the one or more sensors/devices may include a fitness band associated with the participant 106 that detects a start of the physical activity associated with the fixed time timed event based on embedded or in-built sensors and tracks the performance of the participant 106 such as acceleration, speed, orientation, rotation, etc. for the preconfigured or set duration. As another example, the one or more sensors/devices may correspond to the one or more sensors 110 that are placed on the field or the environment in which the assessment is conducted, to sense a start time and various performance-related parameters associated with the participant 106 during the attempt. The one or more sensors/devices may include one or more of: the device 108, the one or more sensors 110, or other sensors/devices as described previously in the description of FIG. 1 and corresponding sensing technology, working methodologies, operations, and/or usage in detecting various performance-related parameters of the participant 106 are applicable accordingly for the fixed time timed event based assessment. The identification and linking of the participant identity information or the participant 106 with the collected sensor data for the timed event with fixed time assessments may be performed in various ways like those described previously for the timed event with fixed amount assessments.

Therefore, in the disclosed embodiments above, the performance-related data of the participant 106 may be captured by the fitness evaluation application either manually by the user 102 or automatically by the one or more sensors/devices at the set time. After capturing the performance-related data of the participant 106, corresponding score may be displayed by the display unit 320 either by manual input of the marking selected by the user 102 or automatically by comparing the performance-related data with the benchmark data. The corresponding score, without limitation, may correspond to a visual indication such as different colors displayed for different performance levels, audio indication such as different audio signals produced for different performance levels, or combination thereof. A result of the assessment i.e., the generated score may be stored in the participants database 314.

Further, the steps involved in setting up the distance measured event are the same as those described for setting up the timed event, and not described again for the sake of brevity. Once the distance measured event is set up, in certain embodiments, the user 102 may conduct the distance measured event. The participant 106 is required to stand at a start point and perform an attempt. The attempt may include, for example, throwing a weighted item, jumping, and the like. Once the participant 106 has attempted the activity of the distance measured event, the user 102 may select, using the control unit 318, a color code for the marker surpassed in the participant's attempt according to the distance covered. The fitness evaluation application may receive and record the input from the user 102 and may display the performance of the participant 106 based on stored scoring tables in suitable databases of the system 202.

In other embodiments, the performance of the participant 106 may be automatically recorded on the fitness evaluation application using sensor inputs from various sensors or devices located in the environment in which the distance measured event is conducted. The sensors or devices for the distance measured events may correspond to a wearable device worn by the participant 106 during the attempt such as the device 108 or may correspond to the one or more sensors 110 placed on track or field where the distance measured event is conducted. As an example, for a standing triple jump event, the one or more sensors 110 may include pressure-sensitive landing pads or touch pads that may detect pressure from the participant 106 as the participant 106 either steps on the respective pad or releases pressure from the respective pad. The detected pressure, speed, and/or time between activation of landing pads may be utilized to compute a performance value of the participant 106 automatically by comparing the detected performance data (or performance-related parameters) with benchmark data retrieved from the system 202 to arrive at a result of the distance measured event assessment. The result of the assessment may be communicated to the user 102, the participant 106, and/or observers in a color-coded manner based on stored scoring tables in the system 202.

Although color coding is described as a form of visual indication for communicating a result of the assessment for the distance measured events in various embodiments noted above, however, without limitation, any form of indication such as star-based rating may be utilized for communicating the result of the assessment to the user 102, the participant 106, and/or observers. The participant's score for the distance measured event may be stored in the participants database 314.

Furthermore, the steps involved in setting up the counted event are same as those described for setting up the timed events and are not described again for the sake of brevity. To conduct the counted event, in certain embodiments, the type of assessment event, the participant identity information (optionally), and the demographic information for the participant 106 are entered on the UI of the fitness evaluation application. Next, the counted event may be attempted by the participant 106, and user 102 may enter the quantity of repetitions performed by the participant 106 using the control unit 318. In other embodiments, instead of manually entering the participant identity information or the quantity of repetitions performed by the participant 106 in the counted events, the participant identity information along with or separately from the performance-related data may be retrieved from different sensors or devices located in the environment in which the assessment is conducted. The different sensors or devices may include one or more of: device 108, one or more sensors 110, or other sensors/devices as described previously in the description of FIG. 1 and corresponding sensing technology, working methodologies, operations, and/or usage in detecting various performance-related parameters of the participant 106 are applicable accordingly for the counted event-based assessment. The retrieved participant identity information, for example, from an ID tag (e.g., an RFID tag), via scanning a QR or bar code, and other similar means for collecting the participant identity information for the participant 106, may be linked to the participant 106 and populated on a dashboard of the fitness evaluation application. Simultaneously or subsequently, retrieved sensor data corresponding to the performance-related data of the participant 106 may be synchronized against the participant identity information (e.g., participant's name) on the UI of the fitness evaluation application.

After the performance-related data of the participant 106 is received by system 102 or the fitness evaluation application either manually or automatically, the system 202 may then generate a score (e.g., color-based score) because of the assessment, and store the result in the participants database 314. The generated score may not be limited to color-coding and may be extended to other implementations such as audio, visual, numerical, alphabetical, or combinations thereof.

Additionally, the system 202, in some embodiments, may generate a composite score (e.g., color score) across all the assessments events for the participant 106. In certain embodiments, considering the eight-color range example, the system 202 may assign a value between one and eight to each color based on position of the color on the scale. Subsequently, an average number for the participant's events may be computed and subsequently the computed number may be rounded to the nearest integer and converted to a composite color score. As an example, any average less than 1.5 may be assigned a white score and any average greater than or equal to 1.5 but less than 2.5 may be assigned a pink score and the like. In alternate embodiments, the composite score may be generated for symbol-based ratings similar to color-coded ratings. As an example, considering five ranges corresponding to star-based symbols where one star is the lowest assessment and five star is the highest assessment on a scale, the system 202 may assign a value between one and five to each of the five stars, and a computed number for participant's events may be converted to a composite star-based score. In further embodiments, the composite score may be computed for alphabetical, numerical, or any other performance indicators in a manner like the embodiments disclosed for composite color scores.

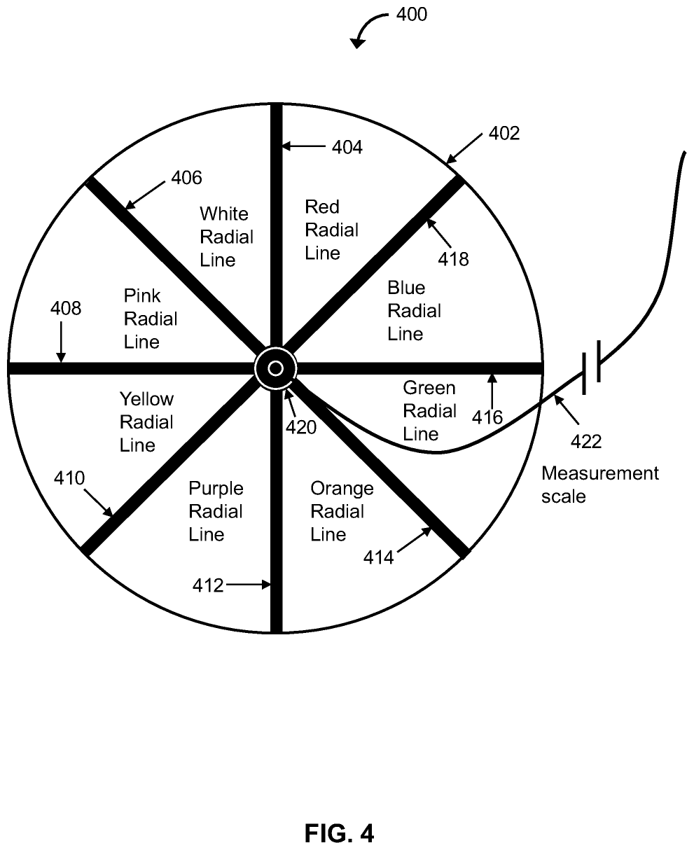

FIG. 4 illustrates a configuration of a mapping tool 400 to set up markings for assessment events. FIG. 4 will be explained in conjunction with the previous figures.

As disclosed previously in the description of FIG. 3, an assessment event may be conducted using the components of the system 202. To evaluate performance of any participant, there may be steps involved in setting up the assessment event and then conducting the assessment event using the fitness evaluation application. To facilitate setting up a course or layout for some assessment events, the system 202 may provide various tools, setup wizards, and guides. A mapping tool 400, such as an octagon course mapping tool, depicted in FIG. 4 is used to set up the markings for assessment events that require markings arranged in an octagon or a circular shaped configuration. The octagon course mapping tool 400 may be used for an “octagon” speed assessment, which is a type of fixed time timed event where the participant 106 is required to run in a predefined octagonal pattern, and the performance of the participant 106 is measured at a preset time. The octagon speed assessment typically evaluates the participant 106 based on performance parameters such as but not limited to running stride efficiency, maximum speed, speed endurance, and balance.

Mapping tool 400 contains a disc 402 with eight radial lines extending from the center 420, namely 404, 406, 408, 410, 412, 414, 416, and 418. Each radial line is positioned 45 degrees from its two adjacent radial lines. Each of the eight radial lines may be colored to match the order of the markings on the course. Without limitation, disc 402 may be constructed from various materials including but not limited to plastic, wood, and paper. In a preferred embodiment, disc 402 would be approximately twenty inches in diameter, but other sizes may be used. In certain implementations, parameters associated with the mapping tool 400 may be fixed to specific values. As non-limiting examples, the mapping tool 400 may be utilized with a two-meter radius for agility tests and an eight-meter radius for speed endurance tests. However, without limitation, in other implementations, the parameters associated with the mapping tool 400 may be variable or dynamically updated for certain types of assessments, demographics, and/or participants.

A measurement scale 422 with length measurement markings may be attached to the center 420 of the mapping tool 400. The measurement scale 422 may include, for example, a string, ribbon, tape, and the like. In an embodiment, the measurement scale 422 may be longer than the largest expected radius of the octagon or circular shaped assessment event course.

To begin with the assessment of the participant 106, the steps described previously for setting up the fixed time timed event will be performed. In certain embodiments, the user 102 may first select or enter the assessment event to be conducted (i.e., octagon speed assessment) on the fitness evaluation application running on the user computing device 104 followed by selecting or entering the participant demographic information.

After the selection or entry of the type of assessment event and the participant demographic information, an optimum layout or configuration for the octagon speed assessment event may be generated by the assessment event course generator 306 corresponding to the demographic information of the participant 106. After the generated configuration, the instructions may be provided to the user 102 or administrator on the UI of the fitness evaluation application for the placement of markers for conducting the octagon speed assessment by the assessment event course setup agent 308.

As part of the instructions provided to use the mapping tool 400 for octagon speed assessment, the user 102 may be required to first place the mapping tool 400 in the middle of the running space or event space. Next, the instructions may guide the user 102 to secure the octagon course mapping tool 400 for stabilization to prevent rotation or translation movement during the usage of the mapping tool 400. Examples of such stabilization means include but are not limited to weights, suction cups to prevent the mapping tool 400 from sliding, studs to prevent the mapping tool 400 from sliding on a grass field, and the like. The user 102 may be required to pull the measurement scale 422 straight to line up with a particular radial line on the disc 402 and place a matching marker (such as a white color cone) at the length of the measurement scale 422 (e.g., 8 m), as suggested by the system 202. The same procedure may be repeated for the placement of the other seven color markers to create an octagon shape. Once the setup of the mapping tool 400 is completed, the participant 106 may position behind the red cone and an attempt for the octagon speed assessment event may include a run of two counterclockwise circuits or laps, for example, around the octagon.

Although a specific configuration of the octagon course mapping tool 400 is described herein, however, without limitation, different versions of the octagon course mapping tool 400 may be provided for different events that require a different order of color markings. As an example, the octagon agility assessment requires the colored markers to be placed in a different order than the octagon speed assessment. As another example, the octagon speed assessment may be conducted across a larger version of the agility assessment course rather than with two counterclockwise circuits.

To conduct the octagon speed assessment set up using the mapping tool 400, the user 102 may open the fitness evaluation application on the user computing device 104 and select/enter the assessment event name (i.e., octagon speed assessment) and the demographic information for the participant 106, such as grade level and/or gender subgroup. The selected demographic information will aid in retrieving the appropriate benchmark data such as 95^{th} percentile, finish time, and fixed time for the run from the databases included in the system 202. Along with or after the selection or entry of the assessment event name and participant demographic information, participant identity information (e.g., name or unique ID associated with the participant 106) may be optionally entered or selected on the fitness evaluation application. The participant identity information, without limitation, may be selected on the UI of the fitness evaluation application in scenarios where it is pre-uploaded to the system 202, or may be entered in real-time at the time of conducting the assessment, or may be automatically scanned/sensed via sensor input as previously disclosed in the description of FIG. 3.

After the selection or entry of relevant information, in certain embodiments, the participant 106 may line up at the start line and the user 102 may depress a button, such as a start button, on a UI of the fitness evaluation application to signal the start of the octagon speed assessment event. In response, an audio signal (e.g., “go” audio signal) may be produced which would indicate to the participant 106 to start running. The participant 106 may run at maximum speed and around the eight color markers twice in the counterclockwise direction. Another audio signal (e.g., stop audio signal) may be produced at a preset time (e.g., 15 seconds), the preset time being generated based on the benchmark data or the demographic distribution data included in the population performance database 316. At that time instant, the user 102 is required to note the last marker (e.g., color marker) passed before the stop audio signal. The user 102, accordingly, may depress or select a corresponding button (e.g., color button) on the UI or dashboard of the fitness evaluation application corresponding to the last color marker. Specifically, for the two laps octagon speed assessment, a participant still running the first counterclockwise lap or having only passed the red marker at the start of the second lap at the stop audio signal may get a white score.

In other embodiments, instead of manual input or selection by the user 102, the start and end timing of the octagon speed assessment event may be automatically detected by one or more sensors/devices in the environment in which the assessment is conducted. The examples of the one or more sensors/devices and corresponding sensing technology as previously disclosed for the fixed time timed events, may be utilized for measuring and detecting the completion of the octagon speed assessment event along with the performance-related data or parameters of the participant 106. Further, the identification and linking of the participant identity information or the participant 106 with the collected sensor data for the octagon speed assessment event may be performed in various ways as previously disclosed for the timed events including fixed time and fixed amount. A sensor sensing the participant identity information may be different or same as a sensor providing performance-related data of the participant 106 for the octagon speed assessment event.

Responsive to the performance-related data being captured by the fitness evaluation application on the user computing device 104 either manually by the user 102 (via selection of a button) or automatically by the one or more sensors/devices at the preset time, a result of the assessment of the participant 106 may be recorded. The result of the assessment may be displayed by the display unit 320 using the stored scoring tables in the system 202 either based on manual input by the user 102 or based on comparison of automatically captured performance-related data from the one or more sensors/devices with the benchmark data. Accordingly, in certain embodiments, the performance of the participant 106 may be displayed in a color-coded manner on the UI of the fitness evaluation application. In other embodiments, the performance of the participant 106 may be displayed via other means such as but not limited to audio, alphabetical, numerical, symbol-based, or combinations thereof. Additionally, or optionally, the user 102 may raise a flag of the color obtained by the participant 106 because of the assessment and may provide a corresponding color dot to the participant 106. Accordingly, the score of the participant 106 may be displayed on the UI of the fitness evaluation application executed on user computing device 104 based on the stored scoring tables in the back-end system 202 or server, and the score indicating the performance of the participant 106 may be stored in the participants database 314.

A person with ordinary skill in the relevant art will recognize that the mapping tool 400 may not be limited to “octagon” shape or to conduct “octagon” speed assessment, and may be readily extended and applied to other shapes such as triangle, square, pentagon, hexagon, etc. and other shape-based assessments. Accordingly, a configuration of the mapping tool 400 may be appropriately defined with corresponding markings to conduct the assessments.

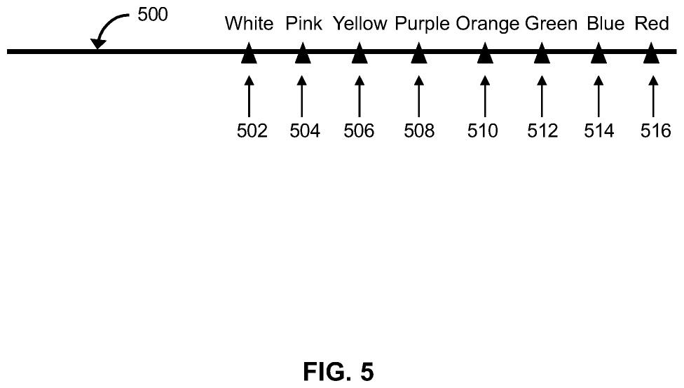

FIG. 5 illustrates placement of color-coded objects on a measurement scale of 500. FIG. 5 will be explained in conjunction with the previous figures.

Analogous to the tools utilized for the timed events (such as the mapping tool 400 illustrated in FIG. 4), the system 202 may utilize the measurement scale 500 for laying out courses for the distance measured events such as but not limited to standing triple jump, javelin throw, and overhead throw. The measurement scale 500 may include, but is not limited to, a measurement string, a ribbon, or a tape. In certain embodiments, the measurement scale 500 may be used to place all markers at distances determined by the system 202 from the population distribution data. Alternatively, the user 102 may perform specific steps or method using the exemplary color scheme to place the markers.

Before conducting the assessment of the participant 106, the steps described previously for setting up the distance measured event may be performed using the measurement scale 500. In certain embodiments, the user 102 may select or enter assessment event name/type and the participant demographic information. In response to the selection or entry of the type of assessment event and the participant demographic information, bounds or width of each range (e.g., color ranges) may be determined by the range generator 304 for the participant demographic and an optimum layout or configuration for the distance measured event may be generated by the assessment event course generator 306 corresponding to the demographic information of the participant 106. Without limitation, any of the methods disclosed previously for associating a color with specific ranges of performance in the distribution may be utilized by the range generator 304. The demographic information of the participant 106 may be utilized to retrieve the benchmarks or the benchmark data (e.g., 95^{th} percentile distance) from the system 202. In scenarios when the benchmark data is updated, the 95^{th} percentile distance (as depicted by red clip 516) and the distance between colors from the range generator 304 may also change. After the generated configuration, the instructions may be provided to the user 102 on the UI of the fitness evaluation application event, by the assessment event course setup agent 308, for the placement of markers for conducting the distance measured event.

As part of the instructions provided to the user 102 to use the measurement scale 500 for the distance measured events, initially, the length of the measurement scale 500 may be measured and the 95^{th} percentile distance may be marked with a red clip. The distance between the remaining clips may be determined by the range generator 304. For the previously described 1/16^{th} method, this distance may be 1/16^{th} of the 95^{th} percentile distance. As a non-limiting example, placement of the remaining clips from the measurement scale 500 can be facilitated by using an adjustable measuring tool set to the color range distance.

An alternative method for placing the clips for the 1/16^{th} method also starts by marking the 95^{th} percentile distance with a red clip. The measurement scale 500 may then be folded in half and the start to red midpoint may be marked with a white clip. Subsequently, the red-white segment midpoint may be marked with a purple clip, the purple-white segment midpoint may be marked with a pink clip, the purple-pink segment midpoint may be marked with a yellow clip, the red-purple segment midpoint may be marked with a green clip, the green-purple segment midpoint may be marked with an orange clip, the red-green segment midpoint may be marked with a blue clip, and the pink-white segment midpoint may be marked with the original white clip. Since the assessment event is distance measured, the measurement scale 500 may be pulled straight from the start in the desired direction of the jump or throw, and corresponding color markers may be placed at the spot for each clip.

In accordance with the above methods, a final placement of the color-coded clips 502, 504, 506, 508, 510, 512, 514, and 516 is depicted in FIG. 5. After placing the markers or clips, the process for conducting the distance measured event is performed. The participant 106 may line up and perform an attempt to throw or jump. Any attempt by the participant 106 that lands before the pink marker or clip 504 may be assigned a score of white. Any attempt by the participant 106 that lands beyond red marker 516 may be assigned a score of red. All other attempts may be scored according to the final color marker that is passed in the attempt. In some implementations, the user 102 may note the last color marker that is surpassed by the jump or throw, and accordingly the user 102 may depress a corresponding color button on the UI of the fitness evaluation application. In response, the fitness evaluation application on the user computing device 104 may record the performance of the participant 106 and may display the performance based on stored scoring tables in the system 202.

In certain implementations, the measurement scale 500 with the clips may be used to measure attempts that land wide of the main line for the event course. The markers in form of clips are depicted and described herein, however, any kind of markers may be utilized for scoring purposes.

It shall be noted that instead of using markers such as clips, in some embodiments, markers with sensors may be used to capture start, end, and location and time information to generate color scores for different assessment events without limitation. Broadly, the performance-related data for the distance measured event conducted using the measurement scale 500 may be captured either by manual input received from the user 102 of the user computing device 104 or automatically in response to sensor data from one or more sensors/devices coupled to the user computing device 104 and located in the environment in which the distance measured event is conducted. Further, the collected sensor data may be linked with the participant 106 by automatically sensing the participant identity information via sensors/devices in the environment or through manual input by the user 102 (via entry or selection of the participant identity information on the UI of the fitness evaluation application) in the scenarios disclosed previously.

Although specific examples of tools used for conducting the assessment are illustrated in FIGS. 4 and 5, however other tools such as but not limited to 5″ color marker, 15″ color marker, 18″ adjustable color markers, color flip charts, agility maps, speed maps, agility hoops, sand bell, turbo javelin, cross bars, and the like may be utilized based on the assessment event type.

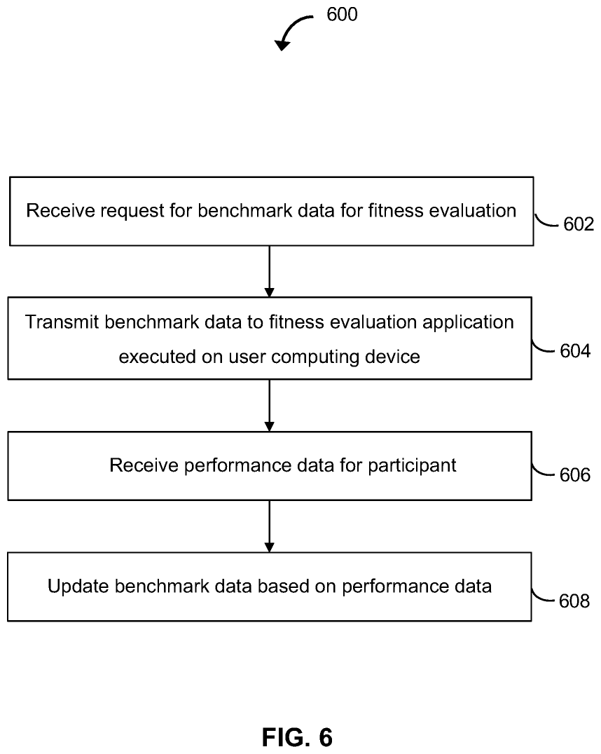

FIG. 6 illustrates an example method 600 for conducting a fitness evaluation of a participant. Method 600 will be explained in conjunction with the previous figures. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example apparatus or system that implements the method 600 may perform functions at substantially the same time or in a specific sequence.

The method 600 begins at step 602 by receiving a request for the benchmark data for fitness evaluation. In an embodiment, the system 202 (or server) may receive the request for the benchmark data from the user computing device 104 via the network 204. The request for the benchmark data may be received by the server 202 in response to a request received by the fitness evaluation application on the user computing device 104 to conduct fitness evaluation for the participant 106. The benchmark data, without limitation, may correspond to one of the 95^{th} percentile score for the assessed participants, an average score obtained by the participants over a predefined time period, one or more metrics for one or more assessment events, a metric corresponding to an aggregated score for one or more events, best or highest score among a set of participants, and the like.

Further, the request may include the demographic information for the participant 106 in the fitness evaluation. The demographic information, for example, may include age, gender, education or grade level, height, weight, BMI, presence of disability, geographic location, training school, and/or level of training/experience in a particular physical activity.

Additionally, the method 600 may include transmitting fitness evaluation course setup information. In an embodiment, the system 202 or server may transmit the fitness evaluation course setup information, as generated by the assessment event course generator 306 and provided by the assessment event course setup agent 308, in response to the request for the benchmark data. Alternatively, the system 202 or server may transmit the fitness evaluation course setup information in response to a separate request for course setup information by the fitness evaluation application executed on the user computing device 104. The transmitted fitness evaluation course setup information may be received by the fitness evaluation application which is adapted to present the received course setup information to the user 102 of the user computing device 104.

The method 600, at step 604, further includes transmitting the benchmark data to a fitness evaluation application executed on a user computing device. In an embodiment, the system 202 (or server) may transmit the benchmark data to the fitness evaluation application executed on the user computing device 104 via the network 204. The benchmark data may be utilized for assessing the participant 106 for the fitness evaluation. Further, the benchmark data may enable the fitness evaluation application running on the user computing device 104 to capture the performance data for the participant 106, as described in FIG. 2, for the fitness evaluation.

In an embodiment, the performance data may be captured by the fitness evaluation application executed on the user computing device 104 for the participant 106 and the captured performance data is received by the system 202 (or the server). In another embodiment, the performance data may be captured for the participant 106 in response to receiving sensor data from a sensor (such as the device 108 and/or the one or more sensors 110) communicatively coupled to the user computing device 104. In yet another embodiment, the performance data may be captured for the participant 106 by receiving a manual input from the user 102 of the user computing device 104. In yet another embodiment, the performance data may be captured for the participant 106 in response to a manual input received from the user 102 of the user computing device 104 and sensor data received from the sensor communicatively coupled to the user computing device 104.

After the performance data for the participant 106 is captured, a relative performance value for the participant 106 may be generated by comparing the captured performance data to the benchmark data. As an example, the performance data and the benchmark data correspond to the same or similar demographic information, and hence the comparison of statistics reveals the performance value for the participant 106 relative to other participants. The relative performance value may correspond to a numerical value, a range, a letter score, and the like. In an embodiment, the comparison of the performance data with the benchmark data and the computation of the relative performance value may be performed by one or more processors of the server 202 or the system processing unit 302.

Further, after the generation of the relative performance value, a visual indicator of the relative performance value may be presented. As an example, the visual indicator may be presented on the UI of the fitness evaluation application on a display screen of the user computing device 104 in a color-coded manner. In such an example, the color-coded assessment of participants may be displayed on a leaderboard or dashboard of the UI of the fitness evaluation application. As another example, the visual indicator may be presented on an external device coupled to the fitness evaluation application such as but not limited to the one or more sensors 110, the timing pod, and the like, as described previously with respect to FIG. 1. As yet another example, the visual indicator may include a band, flag, or any tangible means of a particular color being presented to the participant 106 by the user 102 based on a result of the assessment. As other examples, the visual indicator may include letter(s), number(s), and/or symbol(s) being presented to the user 102, the participant 106, and/or other parties associated with the participant 106. In alternate embodiments, the indication of a performance level of the participant 106 may be presented in a manner other than visual indication.

The method 600, at step 606, further includes receiving the performance data for the participant. The performance data, for example, may include one of a distance travelled over a predetermined time, several exercise repetitions performed in a predetermined time, and a time to travel a predetermined distance. In an embodiment, the performance data may be received by the system 202 (or the server) as part of aggregated performance data for multiple participants in one or more fitness evaluations. In another embodiment, the performance data may be received by the system 202 (or the server) as part of a periodically provided performance data transfer such as but not limited to weekly, monthly, or annual data transfer. The performance data received for the participant 106 is updated in the participants database 314 of the system 202.

Subsequently, at step 608, the method 600 includes updating the benchmark data based on the performance data. In an embodiment, the captured performance data of the participant 106 may be used to update the benchmark data in the system 202 (or the server). The performance data stored in the participants database 314 may be used to update the benchmark data either available or calculated from the population distribution data of the population performance database 316. Updating the benchmark data may be performed in real-time or periodically. The updated benchmark data may be used as a basis for calculating the relative performance values of the participants in subsequent assessments which, in turn, leads to better accuracy of athleticism assessments.

In some embodiments, the method 600 may further include updating course setup information in response to receiving and based on the performance data. The course setup information corresponding to setting up an assessment event course includes placement of markers. The placement of markers for an assessment event may utilize an output of the width of each color range determined by the range generator 304, which further utilizes benchmark data such as percentile scores. As and when the performance data is received by the system 202 or server with associated demographic information, the benchmark data may get updated as described previously, which results in updating the course setup information. The updated course setup information leads to better or optimized layout configuration for a particular assessment event such that the fitness evaluation of participants is performed in a fair manner indicating participant's true capability.

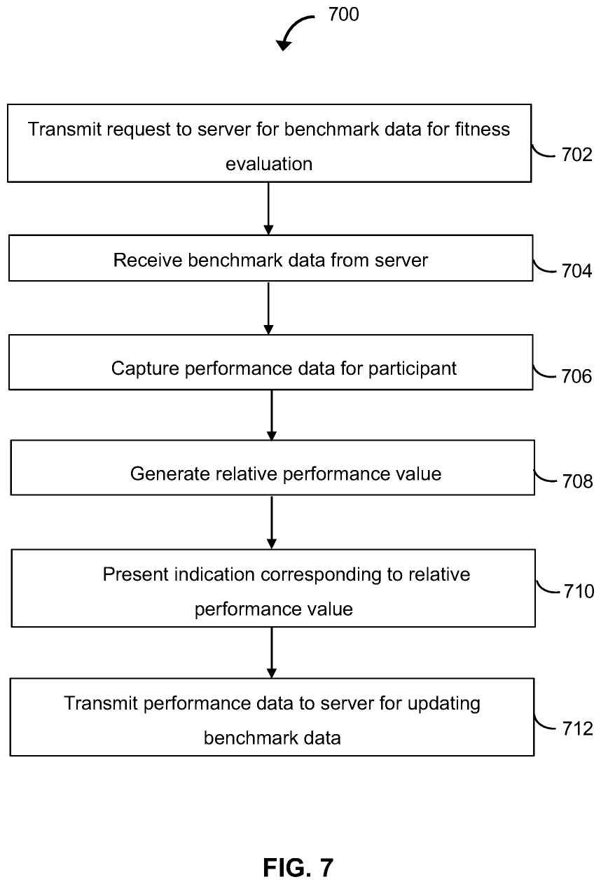

FIG. 7 illustrates another example method 700 for conducting a fitness evaluation of a participant. Method 700 will be explained in conjunction with the previous figures. Although the example utilized for the method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example apparatus or system that implements the method 700 may perform functions at substantially the same time or in a specific sequence.

In certain embodiments, as a pre-requisite requirement for conducting the fitness evaluation, a fitness evaluation application may be installed or downloaded on the user computing device 104 (or client device) through the network 204 (e.g., Internet). The fitness evaluation application running on the user computing device 104 may include GUIs for the user 102 or any person using the fitness evaluation application, to facilitate interaction or communication with the server 202 (or back-end system 202) through the network 204. Although the embodiments are described with respect to the fitness evaluation application being executed on the user computing device 104, however the GUIs may be presented as web pages by the server 202 via a website that may be accessible over the network 204 using a web browser on the user computing device 104. The fitness evaluation may be conducted for the participant 106 using the fitness evaluation application running on the user computing device 104. Without limitation, the user computing device 104 may be associated with the user 102, the participant 106, a family member or someone known to the participant 106, or any observer in the environment in which the assessment is conducted.

The method 700 begins at step 702 by transmitting a request to a server for benchmark data for fitness evaluation. In an embodiment, the user 102 may input or select information including an assessment event type (such as one of the timed events, the distance measured event, or the counted event) and demographic information for the participant 106 on the UI of the fitness evaluation application. Upon receiving the information by the fitness evaluation application on the user computing device 104, the request may be transmitted to the server 202 for benchmark data corresponding to the demographic information for the participant 106.

In response to the transmitted request to the server 202 for the benchmark data, the method 700, at step 704, includes receiving the benchmark data. In an embodiment, the benchmark data may be retrieved or dynamically generated by the server 202 from data stored in the population performance database 316 or other databases of the server 202 based on the demographic information of the participant 106. The server 202 may transmit the benchmark data to the fitness evaluation application executed on the user computing device 104.

In certain implementations, the server 202, upon receiving the request for the benchmark data, may calculate an optimum layout or configuration for the assessment event type using the assessment event course generator 308 and may provide instructions to the user 102 through the assessment event course setup agent 308. In other implementations, the optimum layout or configuration for the assessment event type may be calculated and the instructions for setting up the assessment event may be provided in response to a separate request for setting up the assessment event. The instructions may be provided for using tools and/or placing markers, based on the ranges determined by the range generator 304, for conducting the particular assessment event. As examples, the mapping tool 400 and the measurement scale 500, as depicted in respective FIGS. 4 and 5, may be utilized for conducting the timed event and the distance measured event, respectively.

After the particular assessment event is set up and the participant 106 is ready for assessment, the user 102, upon selecting a particular GUI element on the UI of the fitness evaluation application, may cause initiation of the assessment using different mechanisms (e.g., by producing a start audio signal along with initiating a stopwatch if required) that signals the participant 106 to start an attempt. Based on the type of assessment event, another signal indicating an end of assessment may or may not be produced. As an example, for fixed time timed events, a stop audio signal may be generated at a set time and may not be generated for distance measured events.

After the participant 106 has attempted the physical activity associated with the particular assessment event, the method 700, at step 706, includes capturing the performance data for the participant 106. Based on the type of assessment event, the captured performance data may include one of a distance travelled over a predetermined time, several exercise repetitions performed in a predetermined time, and a time to travel a predetermined distance.

In some embodiments, the user 102 may manually capture the performance data for the participant 106, for example, by selecting a button (or color code) on the UI corresponding to the color marker reached or surpassed by the participant 106 in the attempt. In alternate embodiments, the fitness evaluation application may be configured to capture the performance data for the participant 106 by receiving sensor data from one or more sensors communicatively coupled to the user computing device 104. The one or more sensors may correspond to a wearable device associated with the participant 106 with in-built sensors, a sensor placed on the track or field in which the assessment is conducted, or any sensor capable of monitoring and recording the performance of the participant 106 during the attempt. Without limitation, the one or more sensors, based on the underlying sensing technology, may be capable of detecting a start time and end time of the assessment and may sense various performance parameters associated with the participant 106 during the detected start time, end time, or intermediate time intervals. It will be apparent to a person with ordinary skill in the art that same or different sensor(s) than the ones sensing the performance data for the participant 106 may be utilized to identify the participant 106 automatically, and the collected sensor data may be linked automatically to the participant 106 on the fitness evaluation application. Alternatively, the user 102 may identify the participant 106 and enter participant identity information (e.g., name, ID etc.) at the time of assessment.

In response to the captured performance data for the participant 106, the method 700 further includes generating a relative performance value at step 708. In an embodiment, the relative performance value may be generated by comparing the captured performance data for the participant 106 with the benchmark data for the corresponding participant demographic. The performance value may indicate the performance of the participant 106 relative to other participants in a group. In other words, the relative performance value may be referred to because of the assessment.

The method 700, at step 710, further includes presenting an indication corresponding to the relative performance value. In an embodiment, the indication may be a visual indication presented on a color scale with each color representing a level of performance. Without limitation, the indication may be presented by other means as described throughout the disclosure. The indication of the performance of the participant 106 may be presented to the user 102, the participant 106, or any observer in the environment in which the assessment is conducted.

After presenting the indication, the method 700, at step 712, further includes transmitting the performance data to server for updating benchmark data. In an embodiment, the captured performance data of the participant 106 may be transmitted to the server 202, which upon receipt causes the benchmark data to be updated corresponding to the participant demographic. The updated benchmark data may be subsequently used for assessing participants. Additionally, or alternatively, the indication indicative of the performance of the participant 106 may be stored in the participants database 314 of the server 202, and the update in benchmark data may be performed based on the performance data and/or the indication (e.g., scores, ratings etc.). In certain implementations, the benchmark data may be automatically updated for participants in assessments and assessment events via one or more sensors such as QR readers or similar sensors for machine-readable labels and codes, as disclosed previously.

Among several applications of the system 202 and methods disclosed throughout the disclosure for conducting physical fitness and athleticism assessments, one of the applications may include dynamic reconfiguration of one or more sensors (e.g., device 108, one or more sensors 110, etc.), display devices (e.g., timing pod, lighting tower etc.), and other associated devices based on the updated benchmark data. As an example, the user computing device 104 may transmit reconfiguration parameters to the timing pod or the lighting tower in response to receiving new or updated benchmarks from the back-end system 202. The reconfiguration parameters may cause automatic modification of operational parameters (e.g., when lights are illuminated) of the timing pod or the lighting tower based on a particular participant being assessed for a particular assessment event. As a result, a fully automated sensor-based rating system may be established via interaction, communication, and integration of functionalities between the user computing device 104, sensors, display devices, and/or other devices in the environment in which the assessments are conducted.

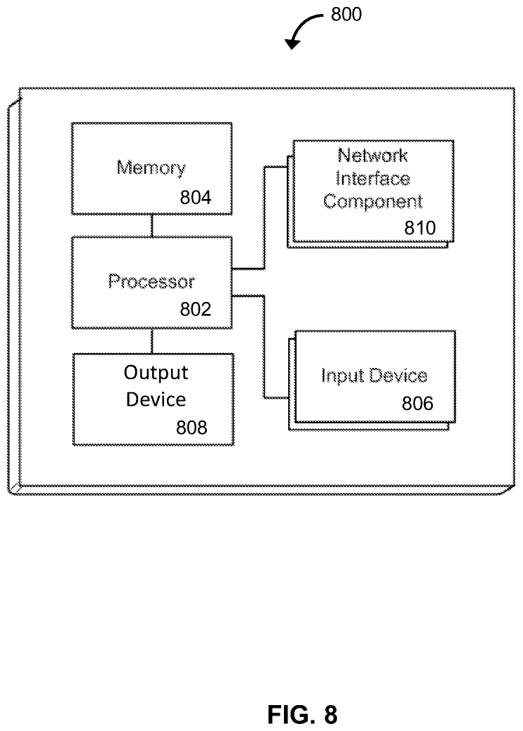

FIG. 8 shows an example of a computing system 800, which may be for example any computing device or computing apparatus including the user computing device 104, the device 108, the one or more sensors 110, the system 202, or combination thereof in which the components of the computing system 800 are in communication with each other using a connection. The connection may be a physical connection via a bus, or a direct connection into a processor 802, such as in a chipset architecture, or the connection may also be a virtual connection, networked connection, or logical connection.

In some embodiments, the computing system 800 may be a distributed system in which the functions described in this disclosure may be distributed within a datacenter, multiple data centers, a peer network, and the like. In some embodiments, one or more of the described system components represent many such components, each performing some or all the functions for which the component is described. In some embodiments, the components may be physical or virtual devices.

The example computing system 800 includes at least one processing unit (CPU or processor 802), and various system components including memory 804, such as read-only memory (ROM) and random-access memory (RAM), are coupled to the processor 802 via the connection. The computing system 800 may include a cache of high-speed memory connected directly with, in close proximity to, or integrated as part of the processor 802.

The processor 802 may include any general-purpose processor as well as a special-purpose processor where software instructions are incorporated into the actual processor design. The processor 802 may essentially be a completely self-contained computing system, containing multiple cores or processors, a bus, memory controller, cache, and the like. A multi-core processor may be symmetric or asymmetric.

The processor 802 could include, or have access to, a non-transitory storage medium, such as the memory 804 that, in some embodiments, is a non-volatile component for storage of machine-readable and machine-executable instructions. A set of such instructions can also be called a program. The instructions, which may also be referred to as “software,” generally provide functionality by performing acts, operations and/or methods as may be disclosed herein or understood by one skilled in the art in view of the disclosed embodiments. In some embodiments, and as a matter of convention used herein, instances of the software may be referred to as a “module” and by other similar terms. Generally, a module includes a set of instructions so as to offer or to fulfill a particular functionality and the processor 802 includes one or more modules. Embodiments of modules and the functionality delivered are not limited by the embodiments described in this document. The term “module” used in this context is intended to be broad and can include hardware, software, distributed components, remote components (e.g., cloud computing), and the like.

In some embodiments, the memory 804 may be a non-volatile memory device and may be a hard disk or other types of computer readable media which may store data that are accessible by a computer, such as magnetic cassettes, flash memory cards, solid state memory devices, digital versatile disks, cartridges, random access memories (RAMs), read-only memory (ROM), and/or some combination of these devices. In some embodiments, the memory 804 may include software services, servers, services, and the like, that when the code that defines such software is executed by the processor 802, it causes the computing system 800 to perform a function. In some embodiments, a hardware service that performs a particular function may include the software component stored in a computer-readable medium in connection with the necessary hardware components, such as the processor 802, an output device 808, and the like, to carry out the function.

To enable user interaction, the computing system 800 includes an input device 806, which may represent any number of input mechanisms, such as a microphone for speech, a touch-sensitive screen for gesture or graphical input, keyboard, mouse, motion input, speech, and the like. The computing system 800 may also include the output device 808, which may be one or more of several output mechanisms known to those of skill in the art. In some instances, multimodal systems may enable a user to provide multiple types of input/output to communicate with the computing system 800. The computing system 800 may include a network interface component 810, which may generally govern and manage the user input and system output. There is no restriction on operating on any hardware arrangement, and therefore the basic features here may easily be substituted for improved hardware or firmware arrangements as they are developed.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service may be software that resides in memory of a user computing device and/or one or more servers of a system and performs one or more functions when a processor executes the software associated with the service. In some embodiments, a service is a program or a collection of programs that carry out a specific function. In some embodiments, a service may be considered a server.

In some embodiments, the computer-readable storage devices, mediums, and memories may include a cable or wireless signal containing a bit stream and the like. However, when mentioned, non-transitory computer-readable storage media expressly exclude media such as energy, carrier signals, electromagnetic waves, and signals per se.

The non-transitory computer readable storage medium may refer to all computer readable media, for example, non-volatile media, volatile media, and transmission media, except for a transitory, propagating signal. The non-volatile media comprise, for example, solid state drives, optical discs or magnetic disks, and other persistent memory volatile media including a dynamic random-access memory (DRAM), which typically constitutes a main memory. The volatile media comprise, for example, a register memory, a processor cache, a random-access memory (RAM), and the like.

Methods according to the above-described examples may be implemented using computer-executable instructions that are stored or otherwise available from computer-readable media. Such instructions may comprise, for example, instructions and data which cause or otherwise configure a general-purpose computer, special purpose computer, or special purpose processing device to perform a specific function or group of functions. Portions of computer resources used may be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, Universal Serial Bus (USB) devices provided with non-volatile memory, networked storage devices, and so on.

Devices implementing methods according to these disclosures may comprise hardware, firmware and/or software, and may take any of a variety of form factors. Typical examples of such form factors include servers, laptops, smartphones, small form factor personal computers, personal digital assistants, and so on. The functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are means for providing the functions described in these disclosures.

Furthermore, while the exemplary embodiments illustrated herein show the various components of the system collocated, some components of the system can be located remotely, at distant portions of a distributed network, such as a local area network (LAN) and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system. For example, the various components can be in a switch such as a private branch exchange (PBX) and media server, gateway, in one or more communications devices, at one or more users' premises, or some combination thereof. Similarly, one or more functional portions of the system could be distributed between a telecommunications device(s) and an associated computing device.

While the flowcharts have been described and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those described above. Hence, the present disclosure and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

Also, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A computer-implemented method comprising:
receiving a request for benchmark data for a fitness evaluation, the request including demographic information for a participant in the fitness evaluation;
transmitting the benchmark data to a fitness evaluation application executed on a user computing device, wherein the benchmark data enables the fitness evaluation application to capture performance data for the participant for the fitness evaluation, to generate a relative performance value by comparing the performance data to the benchmark data, and to present a visual indicator of the relative performance value;
receiving the performance data for the participant; and
updating the benchmark data based on the performance data.

2. The computer-implemented method of claim 1, wherein the benchmark data includes metrics for a plurality of events included in the fitness evaluation.

3. The computer-implemented method of claim 1, wherein the benchmark data includes a metric corresponding to an aggregated score for a plurality of events included in the fitness evaluation.

4. The computer-implemented method of claim 1, wherein the visual indicator is a color scale.

5. The computer-implemented method of claim 1, wherein receiving the performance data includes receiving the performance data as part of aggregated performance data for multiple participants in one or more fitness evaluations.

6. The computer-implemented method of claim 1, wherein receiving the performance data includes receiving the performance data as part of a periodically provided performance data transfer.

7. The computer-implemented method of claim 1, wherein the fitness evaluation application is configured to capture the performance data for the participant by manual input received from a user of the user computing device.

8. The computer-implemented method of claim 1, wherein the fitness evaluation application is configured to capture the performance data for the participant in response to receiving sensor data from a sensor communicatively coupled to the user computing device.

9. The computer-implemented method of claim 1, wherein the performance data includes one of: a distance travelled over a predetermined time, a distance covered during a jump or throw of an object by the participant, a number of exercise repetitions performed in a predetermined time or in a sequence, and a time to travel a predetermined distance.

10. The computer-implemented method of claim 1, further comprising transmitting fitness evaluation course setup information, wherein transmitting the fitness evaluation course setup information is in response to the request for the benchmark data or in response to a separate request for course setup information, and wherein the fitness evaluation application is adapted to receive and present the course setup information to a user of the user computing device.

11. The computer-implemented method of claim 1, further comprising updating course setup information in response to receiving and based on the performance data.

12. A computing apparatus comprising:
a processor; and
a memory storing instructions that, when executed by the processor, configure the apparatus to:
receive a request for benchmark data for a fitness evaluation, the request including demographic information for a participant in the fitness evaluation;
transmit the benchmark data to a fitness evaluation application executed on a user computing device, wherein the benchmark data enables the fitness evaluation application to capture performance data for the participant for the fitness evaluation, to generate a relative performance value by comparing the performance data to the benchmark data, and to present a visual indicator of the relative performance value;
receive the performance data for the participant; and
update the benchmark data based on the performance data.

13. The computing apparatus of claim 12, wherein the fitness evaluation application is configured to capture the performance data for the participant by receiving manual input from a user of the user computing device.

14. The computing apparatus of claim 12, wherein the fitness evaluation application is configured to capture the performance data for the participant by receiving sensor data from a sensor communicatively coupled to the user computing device.

15. The computing apparatus of claim 12, wherein the instructions further configure the apparatus to transmit fitness evaluation course setup information in response to the request for the benchmark data or in response to a separate request for course setup information, and wherein the fitness evaluation application is adapted to receive and present the course setup information to a user of the user computing device.

16. The computing apparatus of claim 12, wherein the instructions further configure the apparatus to update course setup information in response to and based on received performance data for participants in fitness evaluations.

17. A non-transitory computer-readable storage medium, the computer-readable storage medium including instructions that when executed by a computer, cause the computer to:
receive a request for benchmark data for a fitness evaluation, the request including demographic information for a participant in the fitness evaluation;
transmit the benchmark data to a fitness evaluation application executed on a user computing device, wherein the benchmark data enables the fitness evaluation application to capture performance data for the participant for the fitness evaluation, to generate a relative performance value by comparing the performance data to the benchmark data, and to present a visual indicator of the relative performance value;
receive the performance data for the participant; and
update the benchmark data based on the performance data.

18. The computer-readable storage medium of claim 17, wherein the instructions configure the computer to receive the performance data as part of aggregated performance data for at least one of multiple participants and multiple fitness evaluations.

19. The computer-readable storage medium of claim 17, wherein the fitness evaluation application is configured to capture the performance data for the participant in response to manual input received from a user of the user computing device and sensor data received from a sensor communicatively coupled to the user computing device.

20. The computer-readable storage medium of claim 17, wherein the instructions further configure the computer to update course setup information in response to receiving and based on the performance data.
